(19) United States
(12) Patent Application Publication
(10) Pub. No.: US 2026/0217568 A1
(43) Pub. Date: Jul. 30, 2026

(54) IMPROVED METHOD AND SYSTEM FOR TREATMENT OF PFAS CONTAMINATED WASTEWATER AND WATER UTILIZING GAS NANOBUBBLES

(71) Applicant: StreanGo Water Solutions, Inc., Stoney Creek (CA)

(72) Inventors: Marco Polverari, Saint-Leonard (CA); Kevin Hall, Newmarket (CA); Richard Nie, Stoney Creek (CA); Daniel Barrett, Saint Catharines (CA)

(73) Assignee: StreanGo Water Solutions, Inc., Stoney Creek, ON (CA)

(21) Appl. No.: 19/106,897

(22) PCT Filed: Sep. 5, 2023
(86) PCT No.: PCT/CA2023/051166

§ 371 Date: Feb. 26, 2025

Related U.S. Application Data
(60) Provisional application No. 63/403,447, filed on Sep. 2, 2022.
(60) Provisional application No. 63/430,474, filed on Dec. 6, 2022.

(30) Foreign Application Priority Data
Sep. 5, 2023 (WO) PCT/CA2023/051166

(51) Int. Cl. C02F 1/24; C02F 1/32; C02F 1/44; C02F 1/70; C02F 101/30; C02F 101/36; C02F 103/06

(52) U.S. Cl. CPC C02F 1/24; C02F 1/32; C02F 1/441; C02F 1/442; C02F 1/70; C02F 2101/301; C02F 2101/36; C02F 2101/40; C02F 2103/06; C02F 2305/08

(57) ABSTRACT

A method of removing PFAS compounds from a water media includes introducing nanobubbles into the water media to form a nanobubble foam and thereby separate short-chain PFAS compounds from the contaminated water media. The nanobubbles may have a diameter between about 10 nm and 600 nm. A suitable gas or gas mixture is used to generate the nanobubbles. The method removes greater than 95% of the short-chain PFAS compounds from the water media.

### CROSS-REFERENCE TO RELATED APPLICATIONS

This application is a national stage application under 35 U.S.C. § 371 of PCT Application No. PCT/CA2023/051166, filed Sep. 5, 2023, which claims priority to U.S. Pat. Application No. 63/403,447, filed on Sep. 2, 2022, and to U.S. Pat. Application No. 63/403,474, filed on Dec. 6, 2022, all of which are hereby incorporated by reference in their entirety.

### I. TECHNICAL FIELD

This invention relates to a method and system for the decontamination of all water media, such as potable, aquifer, brackish water, leachate water or groundwater containing per- and polyfluoroalkyl substances (PFAS) and related compounds such as PFAS precursors, collectively referred to as PFAS contaminants. This invention also relates to the treatment of PFAS contaminated soils or other materials such as sludge. More specifically, the invention relates to a system and method for concentrating and removing PFAS contaminants from the water media, preferably using ex-situ gas injection but also in-situ, and collection of the resulting foam concentrate for eventual disposal or destruction.

### II. BACKGROUND OF THE INVENTION

The present disclosure relates to methods and apparatus for the remediation of contaminated water and/or soil and, in particular, to the reduction of the concentration of organic compounds in water and/or soil such as the highly recalcitrant halogenated substances, such as poly- and perfluoroalkyl substances (PFAS), that are not readily degraded or destroyed by other chemical oxidation, chemical reduction, combined chemical oxidation/reduction or bio-oxidation methods. The methods and apparatuses described herein may, in some cases, also be effective for less recalcitrant organic compounds of concern.

PFAS are contained in fire-fighting agents such as aqueous film forming foams (AFFF) and as such have been used extensively at facilities such as military bases and airports over the past fifty years. They have also been used in the manufacture of many consumer goods for grease repellency and waterproofing. More recently, long-chained PFAS in particular have been shown to bioaccumulate, persist in the environment, and be toxic to laboratory animals, wildlife, and humans.

Because of their wide use, PFAS effect everyone. PFAS are found in the blood of virtually all humans and animals throughout the world, including newborn babies. The EPA has identified PFOS (Perfluorooctane sulfonate) and PFOA (perfluorooctanoic acid) as emerging contaminants. Approximately 95% of people tested have PFAS in their blood, and PFAS can be detected in human breast milk and umbilical cord blood. Exposure to PFAS over certain levels may result in adverse health effects, including developmental effects, and independent epidemiological studies link numerous adverse health conditions to high exposures of PFOS or PFOA, including kidney cancer, testicular cancer, ulcerative colitis, thyroid disease, pregnancy-induced hypertension, high cholesterol, liver damage, decreased fertility, and decreased antibody response to vaccines. Laboratory animals exposed to PFOS and PFOA have displayed changes in liver, thyroid, and pancreatic function, as well as developmental, immunological, and cancer effects. See Sources: US National Toxicology Program, (2016); C8 Health Project Reports, (2012); WHO IARC, (2017); Barry et al., (2013); Fenton et al., (2009); and White et al., (2011)).

Numerous papers have been written regarding the use, application, health effects, remediation, and destruction of PFAS. See An alternative treatment method for fluorosurfactant-containing wastewater by aerosol-mediated separation, Ina Ebersbach, Svenja M. Ludwig, Marc Constapel, Hans-Willi Kling, Water Research, 101, (2016), pp 330-340. Perfluorinated surfactants possess a high thermal and chemical stability and are not biodegradable. Perfluorooctane sulfonate (PFOS) fulfils the criteria of a PBT-substance (persistent, bioaccumulative and toxic) and has been listed under Annex B of the Stockholm Convention on persistent organic pollutants (POP) in 2010.

PFAS were used largely for their oil and water repellent properties. Applications included consumer products (e.g., raincoats, food packaging, non-stick cookware) and aqueous film-forming foam (AFFF) to fight petroleum-based fires. The chemical properties of PFAS that lead to their use also make their removal from drinking water difficult with conventional water treatment processes.

PFAS are stable because of their carbon-fluorine bonds and are unlikely to react or degrade in the environment. PFAS can attach to soil or sediment and leach to groundwater and surface water, which can impact drinking water sources. Long-chain PFAS are thought to be more likely to attach to soil and sediment than shorter chain PFAS. PFAS may bioaccumulate in plants, animals, and people at levels reported as nanogram/liter (ng/L).

More recently, manufacturers have developed compounds to replace commonly used PFAS that have been phased out of production. Replacement compounds may use fluorinated ether carboxylates to produce shorter-chain PFAS with similar properties as the long-chain compounds. One example of a replacement PFAS is GenX—a perfluoropolyether carboxylate surfactant previously detected in high concentrations in the Cape Fear River in North Carolina as a result of an industrial discharge.

### A. Regulatory Implications

Globally, governments affected by PFAS contamination have been aggressively developing legislation and regulations that govern hazardous organic and inorganic contaminants in the environment. For instance, in the USA, action levels and clean-up standards have been promulgated by both State and Federal governments for numerous organic and inorganic contaminants. The State and Federal regulations that govern these contaminants in the subsurface outline protocols for subsurface investigation to identify the extent of contamination, identification of the human health and ecological risk posed by the contaminants, development of remedial action alternatives for reducing or eliminating any significant risk posed by the contaminants, and selection and implementation of remedial measures to achieve the remediation goals.

The list of regulated organic contaminants that are highly recalcitrant chemicals in the subsurface environment is extensive and includes, but is not limited to, polychlorinated biphenyls (PCBs); halogenated volatile organic compounds (CVOCs), such as tetrachloroethene (PCE), trichloroethene (TCE), trichloroethane (TCA), dichloroethane (DCE), and vinyl chloride; fuel constituents such as benzene, ethylbenzene, toluene, xylene, methyl tert butyl ether (MTBE), tertiary butyl alcohol (TBA), polynuclear aromatic hydrocarbons (PAHs), ethylene dibromide (EDB); pesticides such as DDT; herbicides such as Round Up. Pharmaceuticals, personal care products, micro and nano plastics/beads, aqueous film-forming foam chemicals (AFFF), and coatings.

More recently, the federal and state governments in the US and around the world have begun to regulate a set of new “emerging contaminants” based on discovery of the widespread distribution in the environment and evidence of detrimental toxicological health effects. The new emerging contaminants include poly- and perfluoroalkyl substances (PFAS); 1,4-dioxane, and others.

As PFAS compounds are persistent, toxic, and potentially harmful to humans, the leaching and presence of PFAS in our environment have raised serious concerns globally. Exposure to PFAS through drinking water and various environmental sources has been studied and determined. See State-by-State Regulation of PFAS Substances in Drinking Water|Bryan Cave Leighton Paisner—JDSupra.

In 2021, New York State set a maximum contaminant level of 10 parts per trillion for PFOA and PFOS in drinking water. For context, in 2016, the city's lake reservoir tested with PFAS at 170 parts per trillion-more than twice the Environmental Protection Agency's current health advisory level. Months later, blood tests showed Newburgh residents had almost four times the amount of PFOS in their blood as the general U.S. population.

More recently, on Jun. 15, 2022, the EPA issued interim updated health advisories for perfluorooctanoic acid (PFOA) and perfluorooctane sulfonic acid (PFOS) that replace those EPA issued in 2016 for drinking water. PFOA and PFOS are members of a chemical group called per- and polyfluoroalkyl substances (PFAS). The updated advisory levels, which are based on new science and consider lifetime exposure, indicate that some negative health effects may occur with concentrations of PFOA or PFOS in water that are near zero. At the moment, these much lower levels for PFOA and PFOS compared to previous health advisory levels (HAL), are beyond the capability of the EPA to measure.

At the same time, EPA also issued final health advisories for two other PFAS, perfluorobutane sulfonic acid and its potassium salt (PFBS) and for hexafluoropropylene oxide (HFPO) dimer acid and its ammonium salt (“GenX chemicals”). In chemical and product manufacturing, GenX chemicals are considered a replacement for PFOA, and PFBS is considered a replacement for PFOS. These new HAL are magnitudes of order lower than initial levels.

TABLE 1
Health Advisory Values and Reporting Levels

| | Chemical Health Advisory | Minimum Reporting |
|---|---|---|
| | Value (ppt) | Level (ppt) |
| PFOA | 0.004 (interim) | 4 |
| PFOS | 0.02 (interim) | 4 |
| GenX | 10 (final) | 5 |
| PFBS | 2,000 (final) | 3 |

### B. Treatment Technologies

PFAS have unique chemistry. The carbon-fluorine bond is one of the strongest bonds in nature and it is very difficult to break. In addition, PFOA and PFOS, for example, have a perfluorinated carbon tail that preferentially partitions out of the aqueous (water) phase and an ionic headgroup that partitions into the aqueous phase. (FIG. 1—Properties of PFAS and PFOS). This causes PFAS to preferentially accumulate at air/water interfaces. In addition, PFAS and PFOS have low volatility, high molecular weight, and moderate solubility.

Perfluorochemicals (PFCs) such as perfluorooctane sulfonate (PFOS) and perfluorooctanoate (PFOA) are anionic surfactants with high-energy carbon-fluorine (C—F) bonds that can render them almost indestructible. Current research approaches on the control of PFOXs has been focused on chemical decomposition involving extreme temperature and/or pressure conditions such as thermal- or UV-activated oxidation and ultrasonic irradiation. PFAS are resistant to hydrolysis, photolysis, and aerobic and anaerobic biodegradation.

Many traditional in situ remediation strategies, such as in situ chemical oxidation (ISCO), or bioremediation, are ineffective for treatment of PFAS, because of the strong stability and the physicochemical properties of PFAS that make them recalcitrant. Ex situ sorption-based remediation processes, such as granular activated carbon (GAC) adsorption and anionic resin filtration have had success in treating these compounds. When present, any VOC co-contaminants may compete with PFAS for sorption sites to potentially limit the applicability of these technologies in the field. Recently, nanofiltration has shown promise for PFAS removal. Ex-situ (above-ground) remediation methods involving groundwater extraction and treatment are significantly more costly than in situ methods. Ex-situ remediation methods will require many years of operation until PFAS clean-up targets (ng/L) may be achieved.

These treatment methods have technical and/or economic constraints, mainly due to high energy-consumption, severe reaction conditions and feasibility for low concentration PFAS wastewater. In particular, a minimum concentration of PFAS in the wastewater is required to render destruction economically feasible. Therefore, treatment methods of low energy requirement and high potential for material recovery (e.g., GAC), in lieu of decomposition/destruction, can be cost-effective and highly desirable environmental-friendly alternatives.

Conventional treatment technologies are also ineffective for PFAS removal. PFAS are generally resistant to chemical, physical, and biological degradation, which limits many potential removal mechanisms. Dissolved air flotation, coagulation, flocculation, and sedimentation, granular media filtration (without activated carbon), oxidation, biofiltration, VOC air stripping and low-pressure membranes (UF and MF) provide no remediation.

Because of their high chemical stability, perfluorinated surfactants resist even advanced oxidation processes (AOP). See Comparative study of PFAS treatment by UV, UV/ozone, and fractionations with air and ozonated air, Dai, X, Xie, Z, Dorian, B, Gray, Stephen, and Zhang, Jianhua, Water Re-search and Technology, 5, (2019) pp. 1897-1907.

PFAS may be partially degraded by means of UV/H₂O₂ and O₃ at pH>11, whereas no or only minor degradation was observed using UV, Ho, H₂O₂/Fe₂ or O₃/H₂O₂. See An alternative treatment method for fluorosurfactant-containing wastewater by aerosol-mediated separation, Ina Ebersbach, Svenja M. Ludwig, Marc Constapel, Hans-Willi Kling, Water Research, 101, (2016), pp 330-340.

Thermal treatment can be effective, however, very high temperatures are needed (greater than 1,770 degrees F.) for complete destruction, thereby making ex-situ treatment either impracticable or very expensive. Furthermore, direct destruction technologies are not favoured by most large-scale water treatment plants directly, because strong oxidants/radiation at high dose are required to decompose PFAS, and PFAS concentration in the wastewater is generally at PPB to PPT. However, there are fewer options for the chemical destruction of PFAS compounds by traditional oxidation methods.

There are currently no commercially viable technologies available of using chemical approaches that are capable of degrading or destroying of PFAS compounds of concern to below regulatory limits when the PFAS are present in low concentrations in large volumes of water. Concentration and volume reduction is required for these technologies to become viable.

Membrane filtration such as reverse osmosis (RO) and nanofiltration (NF) can effectively remove PFAS. However, the treatment cost by filtration is considerable for plants treating large volumes of water and is impractical as membrane filtration produces a PFAS concentrated stream (approximately 10-25% of the treated water volume) is produced from RO and NF processes and needs further treatment. At the moment there is no cost-effective way of treating the concentrate stream.

The advantage of the present invention is that reverse osmosis and foam fractionation are effectively combined to result in a highly effective, low-cost alternative compared to traditional reverse osmosis or traditional foam fractionation as stand-only techniques.

### C. Theory of Foam Fractionation

Flotation separation has been widely utilized in industry for the recovery of minerals from ores as well as for the separation or concentration of surfactants, proteins, and metallic ions. See Recovery of perfluorooctane sulfonate (PFOS) and perfluorooctanoate (PFOA) from dilute water solution by foam flotation, Yu-Chi Lee, Po-Yen Wang, Shang-Lien Lo, C. P. Huang, Separation and Purification Technology, (2017), pp. 280-285; PFAS removal from groundwaters using Surface-Active Foam Fractionation, David J. Burns, Paul Stevenson, Peter J. C. Murphy, Remediation, 31, (2021), pp 19-33; The influence of molecular structure on the adsorption of PFAS to fluid-fluid interfaces: Using QSPR to predict interfacial adsorption coefficients, Brosseau, M. L., Water Research, 152, (219), pp. 148-158; Perfluorooctanoic acid (PFOA) removal by flotation with cationic surfactants, Yueh-Feng L, Wei-Yi Chien, Yu-Jung Liu, Yu-Chi Lee, Shang-Lien Lo, Ching-Yao Hu, Chemosphere, 266, (2021), p. 128949.

Furthermore, flotation separation has numerous advantages including low energy and small space requirement, rapid, and easy operation, and low residual concentration of the contaminant in question. Foam flotation processes are based on the premise of the ultimate concentration of surface-active compounds at the gas-liquid interface. When air is bubbled through a solution, the surface-active compounds adsorb onto the rising bubbles, which are then being separated from the solution. If the substance to be removed is not surface active, it can adsorb onto a surfactant (as a collector) first. PFAS, being a surface-active molecule, is an ideal candidate for flotation separation.

Foam fractionation has also been used for separation of the PFAS from wastewater, since PFAS also act as surfactants. The running cost of foam fractionation is low and produces only small amounts of highly concentrated PFAS containing water.

However, the removal efficiency of current state of the art applications of foam fractionation is about 60-80% and is not effective when dealing with-short-chain PFAS. Furthermore, the current state of the art foam fractionation technology does not work well when the concentration of PFAS is very low. In such cases a co-surfactant needs to be added to “aid” the PFAS flotation. Many of the effective co-surfactants are toxic environmentally and also lead to a more complicated process. See Recovery of perfluorooctane sulfonate (PFOS) and perfluorooctanoate (PFOA) from dilute water solution by foam flotation, Yu-Chi Lee, Po-Yen Wang, Shang-Lien Lo, C. P. Huang, Separation and Purification Technology, (2017), pp. 280-285; PFAS removal from groundwaters using Surface-Active Foam Fractionation, David J. Burns, Paul Stevenson, Peter J. C. Murphy, Remediation, 31, (2021), pp 19-33; The influence of molecular structure on the adsorption of PFAS to fluid-fluid interfaces: Using QSPR to predict interfacial adsorption coefficients, Brosseau, M. L., Water Research, 152, (219), pp. 148-158; Perfluorooctanoic acid (PFOA) removal by flotation with cationic surfactants, Yueh-Feng L, Wei-Yi Chien, Yu-Jung Liu, Yu-Chi Lee, Shang-Lien Lo, Ching-Yao Hu, Chemosphere, 266, (2021), p. 128949; Efficient removal of perfluorooctane sulfonate from aqueous film-forming foam solution by aeration-foam collection, Pingping Meng, Shubo Deng, Ayiguli Maimaiti, Bin Wang, Jun Huang, Yujue Wang, Ian T. Cousins, Gang Yu, Chemosphere, 203, (2018), pp. 263-270; Low Energy Water Treatment, AU 2020289754 A1, (2020); Degradation and Removal Methods for Perfluoroalkyl and Polyfluoroalkyl Substances in Water, Nancy Merino, Yan Qu, Rula A Deeb, Elisabeth Hawley, Environmental Engineering Science, 33 (9), (2016), pp. 615-649.

Co-surfactants can be cationic, examples being Cetyltrimethylammonium Bromide (CTAB) or Trimethyloctylammonium bromide (OTAB). Anionic co-surfactants can also be used.

Foam fractionation is an adsorptive bubble separation technique that can remove amphiphilic species dissolved in an aqueous solution. Amphiphiles (or “surfactants”) adsorb onto the surface of bubbles, at the air-water interfaces, to reduce the Gibbs free energy of the system. The technique of foam fractionation is long established. The first authors to use the term “foam fractionation” were Lemlich and Lavi. See Adsorptive bubble separation techniques. Academic Press, Lemlich, R., (1972); Foam fractionation with reflux, Lemlich, R., and Lavi, E. Science, 134, (1961), pp. 191-194. A relatively recent monograph of Stevenson and Li [Foam fractionation: Principles and process design. CRC Press, Stevenson, P., and Li, X., (2014)] focusses on the theory and practical implementation of foam fractionation, although others can now be found. See Foam fractionation applications, Burghoff, B., Journal of Biotechnology, 16, (2012), pp. 126-137.

Furthermore, the hydrodynamic theory of foam fractionation is well known. See Flooding in a Vertically Rising Gas-Liquid Foam, Xinting Wang, Geoffrey M. Evans and Paul Stevenson, Ind. Eng. Chem. Res., 53, (2014), pp. 6150-6156; Hydrodynamic theory of rising foam, Paul Stevenson, Minerals Engineering, 20, (2007), pp. 282-289. In fact, the technology used for PFAS foam fractionation separation and concentration has been utilized for many years in wastewater for the separation of proteins [Efficient removal of perfluorooctane sulfonate from aqueous film-forming foam solution by aeration-foam collection, Pingping Meng, Shubo Deng, Ayiguli Maimaiti, Bin Wang, Jun Huang, Yujue Wang, Ian T. Cousins, Gang Yu, Chemosphere, 203, (2018), pp. 263-270] as well as having found extensive use in aquaria as protein skimmers. See Low Energy Water Treatment, AU 2020289754 A1 (2020).

Foam fractionation in the simplest form uses a gas, typically air or also other gases such as ozone [Comparative study of PFAS treatment by UV, UV/ozone, and fractionations with air and ozonated air, Dai, X, Xie, Z, Dorian, B, Gray, Stephen and Zhang, Jianhua, Water Research and Technology, 5, (2019) pp. 1897-1907], which is bubbled through a vessel, typically a column, filled with an aqueous solution of amphiphiles so that they adsorb to the surface of rising bubbles, which form a froth/foam layer above the liquid pool, and this can be removed/collapsed to form a “foamate” liquid that is enriched in the amphiphile.

The residual liquid at the bottom of the column is depleted in the amphiphile. Essentially, air bubbles act as an adsorbent in much the same way as granular-activated carbon (GAC) does for other applications, but with the advantage that air bubbles are cheap, mobile, and “sustainable,” and do not require disposal after use.

As pointed out by PFAS removal from groundwaters using Surface-Active Foam Fractionation, David J. Burns, Paul Stevenson, Peter J. C. Murphy, Remediation, 31, (2021), pp 19-33, the practical implementation of foam fractionation at a commercial scale cannot be described in such a simple manner. It involves consideration of, for instance, design geometry, method of bubble production, gas flow rate, foamate management, and opportunities for process intensification. See Foam fractionation: Principles and process design. CRC Press, Stevenson, P., and Li, X., (2014). Specifically, the gas flow rate and bubble size dictate the hydrodynamic condition of the foam, which is described by the theory of Stevenson, supra. pH, metal ion concentration and metal ion type has also been found to be an important parameter when not using a co-surfactant. See Recovery of perfluorooctane sulfonate (PFOS) and perfluorooctanoate (PFOA) from dilute water solution by foam flotation, Yu-Chi Lee, Po-Yen Wang, Shang-Lien Lo, C. P. Huang, Separation and Purification Technology, (2017), pp. 280-285.

High Fe3⁺ dose and elevated initial PFOS and PFOA concentration enhanced surfactant removal: PFOS and PFOA removal also increased with decreasing pH with maximum removal occurring at the lowest pH of 2.3 studied; whereas no significant removal was observed at pH>6. At high pH, hydroxide ion (OH−) competed with PFOS or PFOA for Fe3⁺ and formed ferric hydroxo species that impeded surfactant removal. However, by adjusting the pH of the concentrate to 7.0, approximately 84-91% of PFOS and PFOA could be recovered. Two kinds of shorter-chained PFAS compounds, perfluorobutane sulfonamide (FBSA) and perfluorobutane sulfonic acid (PFBS), in particular, are found in real wastewater and the removal of these compounds by current state of the art foam fractionation was less than 20-50% because of the high hydrophilic nature of these compounds. See Recovery of perfluorooctane sulfonate (PFOS) and perfluorooctanoate (PFOA) from dilute water solution by foam flotation, Yu-Chi Lee, Po-Yen Wang, Shang-Lien Lo, C. P. Huang, Separation and Purification Technology, (2017), pp. 280-285.

There are two main reasons for the low removal of short-chain PFAS molecules using SAFF (Surface active foam fractionation) as practiced by people versed in the industry and practitioners in the art at the moment: (1) The low adsorption coefficient of the PFAS species with low C numbers (C5 and less); and (2) The current systems used to generate air are venturi based or similar “large” macrobubble generators.

The first reason for the low removal of the low molecular weight PFAS species is the low adsorption coefficient of the low molecular weight PFAS species to the water-air interface. Data by Brosseau [The influence of surfactant and solution composition on PFAS adsorption at fluid-fluid interfaces, Brosseau, M. L., and Van Glubt, S. Water Research, 161, (2019), pp. 17-26] relate to four subclasses of PFAS: perfluorocarboxylates (PFCAs), branched PFCAs, perfluorosulfonates, and polyfluoroalkyls.

The data of Brosseau [The influence of surfactant and solution composition on PFAS adsorption at fluid-fluid interfaces, Brosseau, M. L., and Van Glubt, S. Water Research, 161, (2019), pp. 17-26] demonstrate a wide range of adsorption coefficients for PFAS species over nearly seven orders of magnitude.

Within each subclass of PFAS, there is a significant increase in such adsorption coefficients as the carbon chain length increases: Long-chain PFAS species are much more susceptible to foam fractionation than are short-chain PFAS species.

As discussed by Burns et al. [PFAS removal from groundwaters using Surface-Active Foam Fractionation, David J. Burns, Paul Stevenson, Peter J. C. Murphy, Remediation, 31, (2021), pp 19-33] long-chain PFAS species are excellent candidates for foam fractionation, but C4 and shorter chain PFAS molecules will barely adsorb at all without the implementation of process intensification techniques. In fact, the data generated by Burns et al show that foam fractionation alone was not generally successful in removing high percentages of short-chain PFAS species. If the design intent is to remove such species, then adsorptive ion-exchange (AIX) polishing is needed, adding cost, and producing a non-sustainable solution. The advantage of the upstream (with respect to AIX) foam fractionation step is that the PFAS loading is vastly reduced, which may result in an extension of the lifecycle of the AIX resin from being prematurely exhausted by high concentration long-chain PFAS species. The disadvantage lies in the cost. The use of AIX resin is an OPEX intensive step which increases the complexity of the treatment trains as well as cost due to low probability of full regeneration of the AIX resin, the high cost of the AIX and the disposal cost of AIX.

Brosseau and Van Glubt [The influence of surfactant and solution composition on PFAS adsorption at fluid-fluid interfaces, Brosseau, M. L., and Van Glubt, S. Water Research, 161, (2019), pp. 17-26] have demonstrated that the presence of electrolytes enhances the adsorption coefficient of PFAS to the gas-liquid interface. It was demonstrated that the removal percentage of PFAS species due to the foam fractionation process generally monotonically increased with adsorption coefficient and this observation indicates that the presence of electrolytes in the feed stream of a foam fractionation unit will increase its efficacy. However, the higher removal efficiency is achieved at high salt concentrations which implies salt addition will be required. Furthermore, given that AIX polishing will also be required, the salt will act as a contaminant to the AIX (or GAC), thus increasing OPEX and CAPEX significantly. The same can be said if nanofiltration or reverse osmosis is used. Furthermore, as discussed Lee et al. [Recovery of perfluorooctane sulfonate (PFOS) and perfluorooctanoate (PFOA) from dilute water solution by foam flotation, Yu-Chi Lee, Po-Yen Wang, Shang-Lien Lo, C. P. Huang, Separation and Purification Technology, (2017), pp. 280-285], the pH will need to be carefully controlled, adding further cost.

The second reason for the low removal of the low molecular weight PFAS species is due to the large macrobubbles produced by Venturi or similar “large bubble” microbubble generators used in currently commercial, state of the art foam fractionation units. See Chemical Engineering and Processing—Process Intensification, Volume 170, January 2022, 108697. Venturi air bubble generators produce larger bubbles with a wide polydispersity with typical bubbles diameters of 0.10-0.40 mm. Id.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

Citation or identification of any reference in Section II, or in any other section of this application, shall not be considered an admission that such reference is available as prior art to the present invention.

### III. SUMMARY

New methods and systems for removing contaminants from a water media utilize nanobubbles to cause a foam fractionation of surface-active molecules such as PFAS. A method of removing contaminants from a water media includes introducing nanobubbles having a diameter less than about 1000 (or about 800) nm into the water media to cause a foam fractionation. The introducing step may include introducing nanobubbles having a diameter between about 10 nm and 600 nm into the water media to cause a foam fractionation. Before the introducing step, there may be an optional step of concentrating the contaminants. An optional step of mineralizing the contaminants may be used after the introducing step. The contaminants may comprise PFAS and/or related compounds including PFAS precursors.

In illustrative embodiments, a method of removing contaminants may include introducing nanobubbles into the water media followed by the sequential injection of micro bubbles or macro bubbles into the water media. The introduction of nanobubbles followed by the sequential injection of micro bubbles or macro bubbles facilitates the foam fractionation process by causing the nanobubbles to float to the top, burst and form a dry foam. In other illustrative embodiments, the nanobubbles and microbubbles/macrobubbles may be injected simultaneously into the water media. This simultaneous injection process also produces a large increase in removal of PFAS. The nanobubbles may be introduced at a first time instant. At least one of microbubbles and/or macrobubbles may be introduced into the fluid at the first time instant. The (1) the nanobubbles and (2) microbubbles and/or the macrobubbles may be generated independent of each other.

An embodiment may include introducing nanobubbles into the fluid at a second time instant subsequent to the first time instant to facilitate foam fractionation and separation of one or more contaminants from the fluid. At least one of microbubbles and/or macrobubbles may be introduced into the fluid at the second time instant. The (1) the nanobubbles and (2) microbubbles and/or the macrobubbles may be generated independent of each other. The method may include injecting (1) the nanobubbles and then subsequently (2) the microbubbles and/or the macrobubbles into the fluid during the first time instant or the second time instant.

In all of the methods, needle wheel pumps may be used to generate the macrobubbles. In all of the methods, a suitable gas may be used to generate the nanobubbles. In all of the methods, a suitable gas may be used to generate the microbubbles and/or macrobubbles. Ozone, pure oxygen, air, or nitrogen are examples of suitable gases, without limitation. In all of the disclosed methods, preferably, co-surfactants are not utilized.

A method of removing contaminants from a water media comprises introducing nanobubbles having a diameter less than about 1000 (or 800 nm) into the water media to cause a foam fractionation. In one embodiment, the introducing step comprises introducing nanobubbles having a diameter between about 10 nm and 600 nm into the water media to cause a foam fractionation. Preferably, the method may include the step of concentrating the contaminants before the introducing step. Preferably, the method may include a step of mineralizing the contaminants after the introducing step.

Also disclosed is a method that comprises introducing nanobubbles into a fluid comprising one or more contaminants to cause fractionation of the one or more components to facilitate removal thereof relative to the fluid. Preferably, the one or more contaminants comprise per- and polyfluoroalkyl substances (PFASs) and related compounds including PFAS precursors. In one embodiment of the method, introducing nanobubbles into the fluid causes the fluid to undergo foam fractionation to cause at least separation of the one or more contaminants from the fluid. In one embodiment, the nanobubbles have a diameter less than 1000 (or 800) nanometers. In another embodiment, the nanobubbles have a diameter ranging between 10 nanometers and 600 nanometers. The method may use needle wheel pumps or similar to generate the macrobubbles.

The method may also include subjecting the one or more contaminants to one or more concentration processes prior to introducing nanobubbles into the fluid, preferably utilizing one or more membrane filtration processes. The method may include the step of removing foam produced during foam fractionation from the fluid. Preferably, causing the fluid to undergo foam fractionation comprises subjecting the fluid to multiple sequential foam fractionation processes.

A method of removing contaminants may comprise: subjecting a contaminated fluid comprising one or more contaminants to an initial membrane filtration treatment to preferably completely remove the totality of the contaminants from the influent and produce a clean permeate and a concentrated reject (Membrane technologies such as reverse osmosis or nano-filtration or any other technology that selectively removes and concentrates PFAS may be useful); subjecting a contaminated fluid comprising one or more contaminants to a first firm fractionator to produce a first contaminate stream, the first contaminate stream comprising a first fluid and a first foamate having a first PFAS concentration; and subjecting the first contaminate stream to at least a second firm fractionator to produce at least a second contaminate stream, the second contaminate stream comprising a second fluid and a second foamate having a second PFAS concentration, the second PFAS concentration being greater than the first PFAS concentration. Preferably, co-surfactants are not utilized.

A method comprising utilizing any suitable gas to generate the nanobubbles, microbubbles or macrobubbles, including, but not limited to, nitrogen, oxygen, ambient air, ozone, or combinations thereof. In one embodiment, an oxidizing gas is added to the gas before it is injected into the nano-, micro- or macro-bubble generator, and is utilized to oxidize PFAS precursors. The oxidizing gas may preferably be ozone.

The above systems for removing contaminants from a water media incorporates nanobubble technology to cause a foam fractionation of surface-active molecules such as PFAS. Removal efficiencies of short chain PFAS molecules (C<7) preferably may be >95% and long chain PFAS molecule (C>6) removals preferably may be >99% for PFAS contaminated water. The preferred method is equally effective with low initial PFAS contaminant concentrations, where a low PFAS concentration is defined as <300 ppt total PFAS concentration. The method and system can be accomplished without use of co-surfactants, anionic, cationic, or non-ionic.

### IV. BRIEF DESCRIPTION OF THE DRAWINGS

The features of the application can be better understood with reference to the drawings described below. The drawings are not necessarily to scale, emphasis instead generally being placed upon illustrating the principles described herein. In the drawings, like numerals are used to indicate like parts throughout the various views.

FIG. 1 shows the chemical structure of PFOA and PFOS.

FIG. 2 shows nanobubble in relation to other bubble types.

FIG. 3A-3F show the first foam fractionation vessel charged with PFAS contaminated water.

FIG. 4 and FIG. 5A/B show a series of ex-situ vertical vessels each with their own aeration and foam collection system.

FIG. 6 shows a schematic of a typical ex-situ treatment system for contaminated water comprising PFAS.

FIG. 7 shows a schematic for a vessel for the removal of PFAS using nanobubbles.

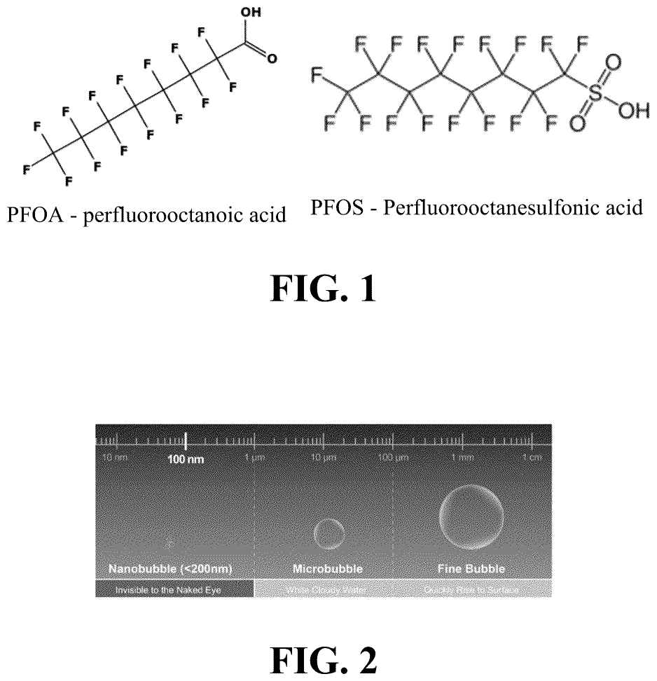

### V. DETAILED DESCRIPTION OF THE INVENTION

The present invention provides an improved method and system for treating PFAS contaminated media, in particular groundwater, ex-situ. This invention differs from prior art as it achieved very high removal of short chain (<C6) PFAS molecules without the aid of a co-surfactant, requires a smaller footprint and less energy input. See PFAS removal from groundwaters using Surface-Active Foam Fractionation, David J. Burns, Paul Stevenson, Peter J. C. Murphy, Remediation, 31, (2021), pp 19-33; The influence of molecular structure on the adsorption of PFAS to fluid-fluid interfaces: Using QSPR to predict interfacial adsorption coefficients, Brosseau, M. L., Water Research, 152, (219), pp. 148-158; Perfluorooctanoic acid (PFOA) removal by flotation with cationic surfactants, Yuch-Feng L, Wei-Yi Chien, Yu-Jung Liu, Yu-Chi Lee, Shang-Lien Lo, Ching-Yao Hu, Chemosphere, 266, (2021), p. 128949; Efficient removal of perfluorooctane sulfonate from aqueous film-forming foam solution by aeration-foam collection, Pingping Meng, Shubo Deng, Ayiguli Maimaiti, Bin Wang, Jun Huang, Yujue Wang, Ian T. Cousins, Gang Yu, Chemosphere, 203, (2018), pp. 263-270; Low Energy Water Treatment, AU 2020289754 A1, (2020); Surface Active Foam Fractionation Treatment Demonstration, Beattie J., Salvetti M., and MacBeth T., CDM Smith White Paper, (2022).

There are many parameters which influence the efficiency of surfactant transport with rising gas bubbles in solution as well as ejection of enriched aqueous phase during aerozolisation. Vecitis determined air-water interface partitioning constants for PFOS, PFHxS, PFBS and PFBA by concentration dependent surface tension measurements. See An alternative treatment method for fluorosurfactant-containing wastewater by aerosol-mediated separation, Ina Ebersbach, Svenja M. Ludwig, Marc Constapel, Hans-Willi Kling, Water Research, 101, (2016), pp 330-340. Lemlich [Adsorptive bubble separation techniques. Academic Press, Lemlich, R., (1972); Foam fractionation with reflux, Lemlich, R., and Lavi, E. Science, 134, (1961), pp. 191-194] observed that increasing the water column and decreasing the inner diameter results in a higher separation value. See An alternative treatment method for fluorosurfactant-containing wastewater by aerosol-mediated separation, Ina Ebersbach, Svenja M. Ludwig, Marc Constapel, Hans-Willi Kling, Water Research, 101, (2016), pp 330-340 By addition of Na₂SO₄ to the solution, a higher separation could be achieved.

In the work of Skop et al. [A model for microbubble scavenging of surface-active lipid molecules from seawater. J., Skop, R. A., Viechnicki, J. T., Brown, J. W., Geophys. Res. Oceans 99, (C8), (1994), pp. 16395-16402] a depletion of surfactants in the solution is described due to the release of aerosols. Further, surfactant transport was found to be higher when gas flow rate was increased. The concentration decrease followed an exponential function and can be described by the following equation, in which Ct is the concentration after a duration of bubbling t, Co the initial concentration and γ the depletion rate constant, which is specific for the surfactant, gas flow rate as well as bubble size distribution.

$$Ct = Co e - γ t \qquad ( 1 )$$

The depletion rate constant γ can be described by the following equation assuming a well-mixed solution as well as constant conditions (number of gas bubbles are constant).

$$γ = [ Nw π d 2 / 4 ] [ β ( f ) η K α \qquad ( 2 )$$

where:
N: Number of bubbles per unit volume of water (cm−3), w: bubble rise velocity (cm s−1),
d: diameter of a single bubble (cm), β (f): factor for correction of the differences of a single bubble from bubbles in a bubble plume, η: contact efficiency (the quantity of surfactant striking a bubble)/(quantity of surfactant passing the bubble), Kα: adsorption coefficient.

What is important to note is that in equations (2), the depletion rate constant is directly proportional to the number of bubbles per unit volume of water (cm³), the diameter of a single bubble (cm), the contact efficiency (the quantity of surfactant striking a bubble)/(quantity of surfactant passing the bubble) and the adsorption coefficient. Thus, a lower C chain PFAS molecule with a lower adsorption coefficient could be removed achieved efficiently using a nanobubble system producing smaller air bubbles and/or more air bubbles.

Table 2 below tabulates the depletion rate constants of selected PFAS molecules with different C-chains as a function of air bubble size:

TABLE 2
Depletion Rate Constants of Selected PFAS Molecules

| | | | | Normalized | | |
|---|---|---|---|---|---|---|
| | | | | Normalized | Normalized | |
| | | | | Ads. Coef. | Ads. Coef. | |
| | | | SAFF | (s⁻¹ · y) | (s⁻¹ · y) | |
| | Number of | | Removal | 100 nm | 1000 nm | Apparent K |
| Species | Carbons | K(um) | (%) | bubble | bubble | (um) |
| PFHxA | 6 | 0.22 | 46.7 | 100000 | 10000 | 2.2 |
| PFHxS | 6 | 0.97 | 98.4 | 100000 | 10000 | 9.7 |
| PFOA | 8 | 2.3 | 99.8 | 100000 | 10000 | 23 |
| PFDA | 10 | 37 | 98.9 | 100000 | 10000 | 370 |

A recent publication by Meng and al. [Efficient removal of perfluorooctane sulfonate from aqueous film-forming foam solution by aeration-foam collection, Pingping Meng, Shubo Deng, Ayiguli Maimaiti, Bin Wang, Jun Huang, Yujue Wang, Ian T. Cousins, Gang Yu, Chemosphere, 203, (2018), pp. 263-270] has confirmed these observations. Meng demonstrated that bubble stability was an important criterion. A high concentration of PFOS in the foam was preferable for the stability of air bubbles, preventing foams from breaking and increasing foam volume. If the concentration of PFOS was low, bubble stability decreased and the PFOS removal percent also decreased.

Another important parameter was ionic strength. Meng showed that increased ionic strength (by adjusting the concentration of NaCl in the solution) on PFOS elimination was beneficial for the removal of PFOS by aeration-foam collection. This effect can be explained by a reduction in solubility (increased hydrophobicity) making it more preferable for the PFOS to adsorb on the surface of air bubbles. See Efficient removal of perfluorooctane sulfonate from aqueous film-forming foam solution by aeration-foam collection, Pingping Meng, Shubo Deng, Ayiguli Maimaiti, Bin Wang, Jun Huang, Yujue Wang, Ian T. Cousins, Gang Yu, Chemosphere, 203, (2018), pp. 263-270.

Also, the diameter of air bubbles was found to be smaller at higher ionic strength. The addition of electrolytes lowered the hydrophobic attractive force between approaching bubbles by hydrating their surfaces, therefore inhibiting the bubble coalescence, and decreasing the size of air bubbles resulting in an increase in the total available surface area for adsorption at the air-water interface.

Finally, the ionic strength played an important role in the stability of the air bubbles in the solution and foams on the top of the solution. On one hand, the zeta potential of air bubbles was negative under most circumstances, creating an electrostatic repulsion between air bubbles preventing them from merging with other bubbles and bursting. Therefore, a higher ionic strength strengthens the negative zeta potential and stabilizes the air bubbles due to higher electrostatic repulsion, making the air bubbles less likely to break up. During flotation in solution, an increase in the stability of air bubbles increases the contact time with the dissolved PFOS.

Ionic strength, bubble size, hydrophobicity and bubble stability are four parameters in equation (2) that influence percent removal by foam fractionation, in particular when the initial PFAS concentration is low in solution. However, these parameters are difficult to control in large scale systems.

As an alternative means, other practitioners in the field have found that the addition of a cosurfactant, such as N-octyl-beta-D-glucopyranoside, increased both the volume of the foam and the removal rate of PFOS. Surfactants are well-known for their ability to decrease the surface tension and increase the stability of air bubbles in solution. Decreasing the surface tension by adding surfactants increases the stability of the air bubble. Meng showed that the addition of a cosurfactant increased the total amount of surfactants in solution, which helped to stabilize the air bubbles and thus assisted PFOS removal through increased foam formation.

Aeration-foam collection has been demonstrated to also be effective for the removal of low molecular weight (carbon chain <6) PFAS from aqueous solutions under different conditions. Under normal conditions this is not possible under any starting concentration. Considering new substitutes of PFOS used in the AFFF industry as well as the wide range of other PFAS contamination problems, it is important to know whether this method is effective for other PFAS. Short-chain PFAS such as PFHxS, PFHxA, PFBA and PFBS are the most common substitutes for PFOS in AFFF products. Typical results for short chain PFAS show a 20-40% removal rate without co-surfactant and 50-60% with co-surfactant. The short-chain PFASs like PFBS, PFHxA and PFHxS are more soluble in water and less surface active and thus they are more weakly adsorbed at the air-water interface than PFOS. Burns et al explained these phenomena in terms of adsorption coefficient. See PFAS removal from groundwaters using Surface-Active Foam Fractionation, David J. Burns, Paul Stevenson, Peter J. C. Murphy, Remediation, 31, (2021), pp 19-33.

The current invention aims to overcome the drawbacks and weaknesses in the current technology by using nanobubble technology, a new technology. The disclosed invention utilizes nanobubble technology for application in foam fractionation of surface-active molecules such as PFAS instead of coarse aeration provided venturi tubes.

The claimed nanobubble technology achieves:
1. Removal efficiencies of short chain molecules of >90%;
2. High PFAS removals (>90%) for PFAS contaminated water with low initial PFAS concentration. Low PFAS concentration is defined as <300 ppt total PFAS concentration.
3. No requirement for a co-surfactant to be added to “aid” the PFAS flotation, thus will nor contribute to toxicity to the environment.

Prior art has relied on ceramic diffusers and venturi tube technology to produce bubbles for vessel aeration. Ceramic diffusers at best can create air bubbles no smaller than 100 μm. The most efficient venturi has been found to generate bubbles with size down to, at best, 780 nm. See Chemical Engineering and Processing-Process Intensification, Volume 170, January 2022, 108697. The reason is mainly economic as venturi tubes produce air bubbles efficiently at low cost and are not prone to blockage. However, even at optimum efficiency, the best venturi typically produces bubbles in the range of 0.1-3 mm in diameter.

Nanobubbles are defined as air bubbles with a diameter typically <1000 nm or 1<800 nm, preferably between 10 and 600 nm, optimally 200 nm. Ordinary fine bubbles (>1 nm diameter) quickly rise to the surface and burst but the smaller nanobubbles (<100 nm diameter) have a lower buoyancy and will remain suspended in liquids for an extended period of time. The stability of nanobubbles is not well understood but is thought to be a balance of the van der Waal's force of attraction and the electric double-layer force of repulsion between neighboring nanobubbles, with additional contributions from the virtual disappearance of buoyant force, bridging nanobubbles, entropic restriction, and fluid structuring.

Nanobubbles which are <100 nm in diameter will randomly drift owing to what is termed Brownian motion and can remain in liquids for an extended period of time. Most importantly, nanobubbles are hydrophobic: they repel water and strongly attract the hydrophobic tail of the PFAS molecules, regardless of C chain length. Nanobubbles in the water serve as seeds where the PFAS molecule “aggregate.”

FIG. 2 compares nanobubbles, microbubbles and fine bubbles. As can be seen, nanobubbles are easily differentiated in aqueous solution by the fact that they are invisible to the naked eye. Nanobubbles are nano size bubbles, 2500× smaller than a grain of salt which lack the buoyancy to float to the surface and “pop”. Nanobubbles with a 100 nm diameter will have 10 times greater interfacial surface and 1000 more air bubbles per unit area compared to microbubbles with a 1 μm diameter.

The combination of the nanobubble aeration system's larger total interfacial surface area, higher air bubble density and hydrophobicity, increases the attraction and collision rate of the PFAS molecules with the suspended air particles, resulting in a higher percentage of PFAS attaching to the air bubbles and consequently removed from the water. Nanobubble fulfill the requirements set out above without the need of a co-surfactant: small bubble size, hydrophobicity, and high bubble stability.

### Definition of Contaminants and Co-Contaminants

The first group of contaminants comprises the total PFAS concentration. Per and polyfluoroalkyl substances (PFAS) are a group of man-made chemicals that includes perfluorooctanoic acid (PFOA), perfluorooctanesulfonic acid (conjugate base perfluo-rooctanesulfonate) (PFOS), Per-fluorohexanesulfonate (PFHxS), GenX, and many other chemicals defined as forever chemicals. There are thousands of PFAS compounds, most likely about 3000+. Some PFAS compounds are regulated. In certain preferred embodiments, the method is intended to treat wastewater to remove regulated PFAS compounds. GenX is a trade name for a technology that is used to make high performance fluoropolymers (e.g., some non-stick coatings) without the use of perfluorooctanoic acid (PFOA). Hexafluoropropylene oxide-dimer acid (HFPO) dimer acid and its ammonium salt are the major chemicals associated with the GenX technology. Other contaminants can also be treated with the disclosed system.

The second group of contaminants include contaminants that are not PFAS, but which may be the subject of embodiments of the disclosed methods. The contaminants can be one or more of (but not limited to) total petroleum hydrocarbons (TPH), including benzene, toluene, ethylbenzene, and xylene (BTEX); and Halogenated Volatile Organic Compounds, including 1,2-dichloroethane (DCE), 1,1-dichloroethane, trichloroacetic acid (TCA), tetrachloroethylene (PCE), and trichloroethylene (TCE). The group may also include non-petroleum Hydrocarbons (methanol and isopropyl ether). Other contaminants which will also be reduced include: Acetone, PAHs (naphthalene, and 2- and 3-ring PAHs), MTBE, MIBK, MEK.

In summary, foam fractionation is ideally suited to physically remove the priority PFAS molecules (including other theoretical non-PFAS co-contaminates) allowing more sophisticated (and expensive) techniques to be reserved as polishing treatments to achieve concentrations below criteria for regulated disposal or discharge.

### Process

The present process preferably removes PFAS upfront to reduce the likelihood of the regulated compounds requiring treatment in resultant waste and to do so cost effectively in the presence of a range of co-contaminants.

In a first aspect, there is provided an above ground low energy method of decontaminating, for example, but not limited to, wastewater, drinking water, leachate water, or brackish water contaminated with at least one PFAS and possibly at least one co-contaminant, for example, volatile organic compounds (VOC) such as 1,2 dichloroethane (DCE) but not limited to, the method comprising the steps of:
(a) optionally concentrating the PFAS before aeration, using for example, membrane technology;
(b) removing the PFAS using aeration and the first group of contaminants; and
(c) mineralizing the third (or last wastewater stream) to destroy all PFAS;
   Step (a) is an optional step.

The objective is to produce a water suitable for potable use which is either PFAS free or below regulatory PFAS limits suitable for potable water applications. The water produced can be further treated or polished with adsorptive technologies such as activated carbon or anionic ion exchange resin, is required. Regardless, the water produced in step (a) should at minimum be of a quality good enough for direct discharge into the environment.

In step (a), the PFAS is preferably removed and concentrated using membrane filtration. This can be done by using membrane technologies such as reverse osmosis or nano-filtration or by any other technology that selectively removes and concentrated PFAS from the wastewater.

Step (a) produces a waste stream of PFAS concentrated wastewater. The reject ratio of PFAS and co-contaminant concentrated wastewater when using membrane technologies (also called reject ratio when using reverse osmosis or nanofiltration) can be up to 50% but preferably less than 25%. Most explicitly the PFAS concentration ratio of final to initial concentration (concentration ratio) can be, if recycling occurs, up to 1000 for step (a). The co-contaminant concentration will vary on co-contaminant properties but can also be up to 1000.

In step (b), the removal of PFAS is undertaken by providing an above-ground or in-ground low-energy method of generating a highly PFAS concentrated-waste stream, comprising:
actively-aerating a PFAS contaminated wastewater directly from a contaminated source or from step (a) in a first vessel to produce a first waste stream having a first PFAS and co-contaminant concentration. The concentration ratio can be up to 1,000, but may be 10, 20, 30, 40, 50, 100, 200, 300, 400, 500, 600, 700, 800, or 900.
actively aerating the first waste stream having a first PFAS concentration in a second vessel to produce a second waste stream having a second PFAS concentration, and a second liquid stream having at least some of the first group of contaminants wherein the second PFAS concentration is higher than the first PFAS concentration. The concentration ratio can be up to 10,000, but may be 1000, 2000, 3000, 4000, 5000, 6000, 7000, 8000, or 9000.
passing the second waste stream having a second PFAS concentration through a further process to produce a third waste stream having a third PFAS concentration, and a third liquid stream having at least some of the first group of contaminants wherein the third PFAS concentration is higher than the second PFAS.

In step (c), the third or final PFAS containing wastewater stream is treated so as to mineralize the PFAS and co-contaminants in solution.

A wide variety of technologies to remove or destroy PFASs have been tested by researchers and practitioners: (1) sorption using activated carbon, ion exchange, or other sorbents, (2) advanced oxidation processes, including electrochemical oxidation, photolysis, and photocatalysis, (3) advanced reduction processes using aqueous iodide or dithionite and sulfite, (4) thermal and nonthermal destruction, including incineration, sono-chemical degradation, sub- or supercritical oxidation treatment, microwave hydrothermal treatment, and high-voltage electric discharge, plasma, (5) microbial treatment, and (6) other treatment processes, including ozonation under alkaline conditions, permanganate oxidation, vitamin-B12 and Ti (III) citrate reductive defluorination, and ball milling.

Preferably a photoactivated reductive defluorination (PRD) is used. PRD is a unique chemistry coupled with ultraviolet light to stimulate a reaction which systematically disassembles and mineralizes PFAS molecules to water, fluoride, and simple carbon compounds. The process is described in patents [Method for Degrading Perfluorinated Compounds, U.S. Pat. No. 11,072,574 B2; Method for Degrading Perfluorinated Compounds, U.S. Pat. No. 9,896,350 B2] and literature [Application of Surfactant Modified Montmorillonite with Different Conformation for Photo-Treatment of Perfluorooctanoic Acid by Hydrated Electrons, Chen, Z., Tian, H., Li, H., Li, J., Hong, R., Sheng, F., Wang, C., Gu, C., Chemosphere. 235, (2019), pp. 1180-1188. DOI: 10.1016/j.chemosphere.2019.07.032; Efficient Reductive Destruction of Perfluoroalkyl Substances under Self-Assembled Micelle Confinement, Chen, Z., Li, C., Gao, J., Dong, H., Chen, Y., Wu, B., Gu, C., Environmental Science and Technology 54 (8), (2020) pp. 5178-5185. DOI: 10.1021/acs.est.9b06599; Complete Defluorination of Perfluorinated compounds by Hydrated Electrons Generated from 3-Indole-acetic-acid in Organo modified Montmorillonite, Tian, H., Gao, J., Li, H., Boyd, S., Gu, C., Scientific Reports 6:32949 (2016). DOI: 10.1038/srep32949; Effects of different factors on photodefluorination of perfluorinated compounds by hydrated electrons in organo-montmorillonite system, Tian, H., Gu, C., Chemosphere. 191, (2018), pp. 280-287. DOI:10.1016/j.chemosphere.2017.10.074].

In another embodiment, the first foam fractionation vessel is charged with PFAS contaminated water. The water will have been pretreated to remove iron and magnesium, if required, and cleared of TSS if required. This is typically done with a DAF, but other pre-treatment technologies can be used, based on evaluation of the initial water properties.

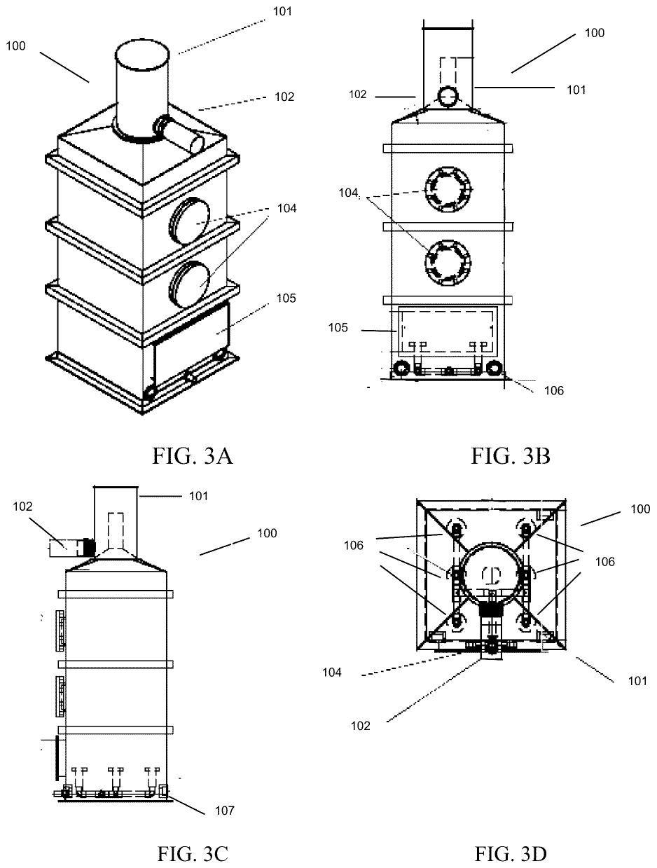

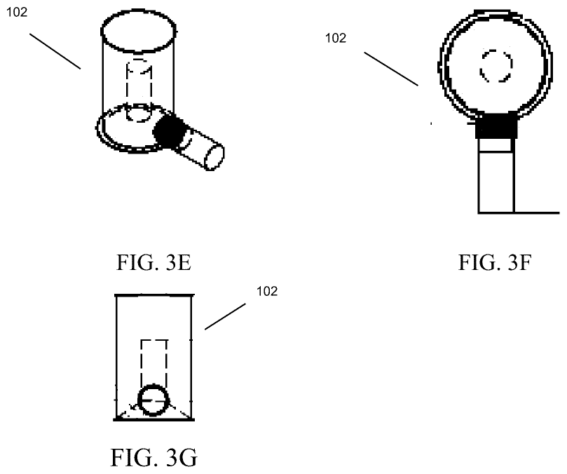

The foam produced by the air injection into the vessel is removed by applying a vacuum to tube(s) that are located at the top of the vessel in the vessel cap as shown in FIGS. 3A and 3B. Once the foam/air mixture is removed from the well it is piped to a sealed knock-out vessel where the foam condenses to a liquid and the air is discharged. The foam is concentrated with PFAS compared to the initial untreated media. The liquid concentrate can be further treated through a secondary vessel or series of vessels or removed by adsorption or destroyed by thermal incineration, for example, either on- or off-site. The clean water discharge can be further treated on-site using activated carbon, for example, if necessary.

FIGS. 3A-3G shows an embodiment of the foam fractionation vessel (100) in ISO view (3A), plan view (3D), elevation view (3B) and side view (3C). The vessel has a vessel cap (101), preferably removable, which may be made of clear plastic. The vessel cap 101 is shown in ISO view (3E), top view (3F) and front view (3G). The vessel cap 101 may preferably have one or more removable PVC nipples (102) with one or more nozzles (103). There may be one or more site glasses (104) and a maintenance manway (105). There may be internal nozzles for diffusers (106) and nozzles at the bottom of the tank (107). A second foam fractionation vessel may have a similar structure.

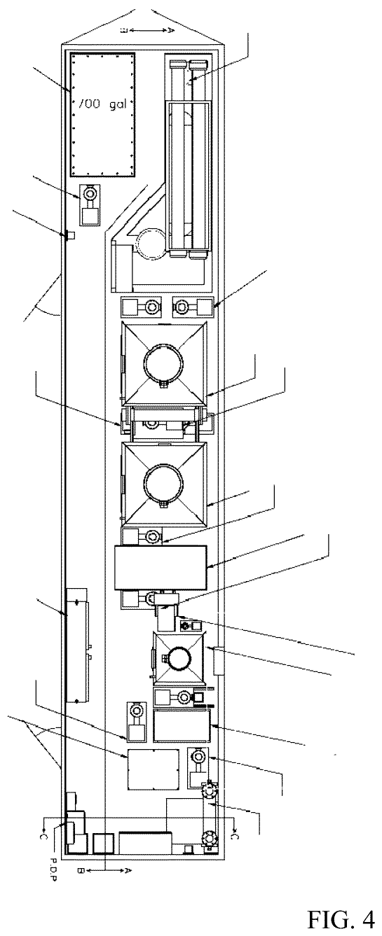

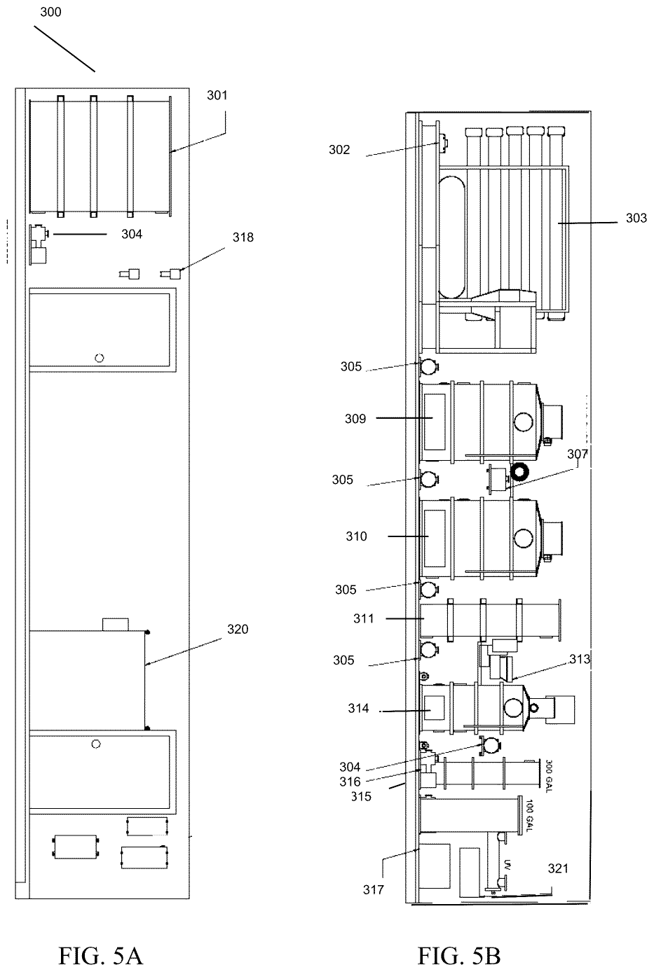

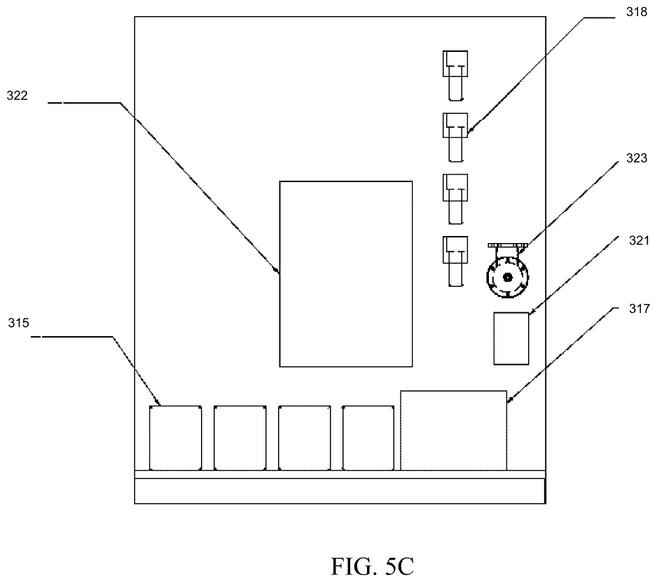

An embodiment of the invention can be configured as described above with a series of vessels as shown in FIGS. 4 and 5 which progressively reduce the PFAS concentration in the media. FIGS. 4 and 5 describe a series of ex-situ vertical vessels each with their own aeration and foam collection system. Below-ground configurations (in-situ) are also possible using wells instead of vessels. FIG. 4 (shown in landscape due to page size constraints) shows the plan view. FIG. 5A (shown in landscape due to page size constraints) shows an elevation view of the interior south wall. FIG. 5B (shown in landscape due to page size constraints) shows an elevation view of the interior north wall. FIG. 5C shows an elevation view of the interior east wall.

An embodiment of the system (300) may include at least one holding tank (301). The system may also include an air compressor (302) and an R/O system (303). The system may also include at least one transfer pump (304), at least one needle pump/microbubble pump (305), and at least one nanobubble pump (307). The system may include a first primary tank (309) and a second primary tank (310). The system may also include a primary holding tank (311), and at least one foamate drain pump (312). The disclosed system may also include one or more vacuum pumps (313), a foamate holding tank (314), one or more tanks (315), one or more recirculation pumps (316), one or more chillers (317), one or more chemical pumps (318), and a destruction recirculation tank (319). In addition, the system may include an electrical cabinet (320), monitoring probes (321) and a UV connector panel (322) and UV (323).

It should be understood that the invention is not limited to foam fractionation and other active aeration processes are within the scope. Where foam fractionation is referred to herein it should be understood that other active aeration processes can equally apply. Other methods of aeration that could be relevant include Jet Aeration or Stripping with a foam removal step. Another type of active aeration is Dissolved Air Flotation (DAF). Induced Aerated DAF could also be used. SAF can also be used. DAF and SAF are water treatment processes that clarify wastewater by removing suspended solids. The removal is achieved by dissolving air in the water or wastewater under pressure and then releasing the air at atmospheric pressure in a flotation tank.

In one embodiment, the first primary tank is a foam fractionator. The second primary tank may also be a foam fractionator. In another aspect there is provided an above ground method for generating a highly PFAS concentrated waste stream, comprising:
passing PFAS contaminated waste through a first foam fractionator at a flow rate to provide a retention time of at least 10 minutes to produce a foamate having a first PFAS concentration and/or leaving PFAS contaminated waste in the first foam fractionator and to treat it as batch with a treatment time of at least 10 minutes and/or a combination of both batch and flow through.
passing the foamate through a second foam fractionator at a flow rate to provide a retention time of at least 10 minutes to produce a second foamate having a second PFAS concentration and/or leaving PFAS contaminated waste in the first foam fractionator and to treat it as batch with a treatment time of at least 10 minutes and/or a combination of both batch and flow through.
passing the second foamate through a “further process” to produce a waste stream having a third PFAS concentration; wherein the third PFAS concentration is higher than the second PFAS concentration.
Passing the treated PFAS contaminated wastewater from the first, second, third and/or subsequent further processes through a “polishing process” to achieve the desired contaminant level.

In an embodiment the “further process” in any one of the aspects of the invention described is a further stage (third stage) of active aeration. In this embodiment there are therefore three stages of active aeration. The three stages of active aeration can comprise the first aeration stage in the first primary tank which produces a waste stream comprising a concentration of PFAS and a first water stream. The second aeration stage in the second primary tank which further concentrates the PFAS in a second waste stream, and also generates a second water stream. And a third aeration stage in a third vessel or tank which actively aerates the second water stream in a third vessel. The vessels can be the same, or the vessel can become sequentially smaller in volume. There can be more stages of active aeration in sequence if required, but it is preferable to reduce the number of stages so as to increase performance efficiency.

In another embodiment the “further process” is a PFAS or mineralization stage where the foamate is passed through preferably a photoactivated reductive defluorination (PRD) system. PRD is a unique chemistry coupled with ultraviolet light to stimulate a reaction which systematically disassembles and mineralizes PFAS molecules to water, fluoride, and simple carbon compounds.

In an embodiment, “polishing process” is a further step necessary for example if it is desirable to take PFAS (e.g., PFOA) to a non detectable level in the treated liquid stream. Such a process is preferably, but not limited to:

### Activated Carbon:

Depending on the treated water properties, it may be possible to use Granular Activated Carbon (GAC) on the treated water. The process can be evaluated by undertaking isotherm testing, to assess GAC capacity with the treated water. The use of GAC will generate spent GAC requiring disposal but offers a pathway to remove PFAS from foamate noting the large volume reduction that is passing through.

The treated water potentially could be pumped through a GAC column to adsorb contaminants. Adsorption is both the physical and chemical process of accumulating a substance at the interface between liquid and solids phases. Activated carbon is an effective adsorbent because it is a highly porous material and provides a large surface area to which contaminants may adsorb. The two main types of activated carbon used in water treatment applications are granular activated carbon (GAC) and powdered activated carbon (PAC). PFAS and other compounds will be adsorbed into the GAC. The GAC is usually disposed of once expended.

### Ion Exchange:

Anion exchange has also been used for the removal of PFAS's from treated water but is not appropriate in raw leachate due to the high ion concentrations. However, depending on the treated water characteristics, it may be a practical option. Ion exchange is an exchange of ions between two electrolytes or between an electrolyte solution and a complex. In most cases the term is used to denote the processes of purification, separation, and decontamination of aqueous and other ion containing solutions with solid polymeric or mineral. Ion exchange is as the name suggest the exchange of one ion for another. Remove one ion of contaminant and release an ion of that we can tolerate or deal with at a later stage. The Ion Exchange resin requires regeneration when expended. This will require additional chemicals (Acids/Bases) which will require disposal.

Nano-Filtration and/or Reverse Osmosis:

Nano-filtration and/or reverse osmosis have been demonstrated as methods of separating PFAS's from groundwater. Whilst this is practical in a small volume and low TDS water, it is not suited to the raw leachate. Nano filtration or RO provides a membrane which the PFAS components cannot pass through.

In a further embodiment, it may be necessary to go through multiple passes of the foam in fractionator four in order to achieve the desired PFAS removal. The first process and/or the second process and/or the third active aeration process and/or the fourth active aeration process (and any other stages of active aeration) are optimised by selecting, controlling and/or adjusting the gas flowrate of e.g., the foaming process; the aeration residence time during e.g., the foaming process; bubble size; extraction device, liquid pool depth; liquid residence time. The skilled person familiar with active aeration will readily understand how to modify the active aeration processes to achieve the results based on their own knowledge and combined with the teachings herein.

Optionally, a co-surfactant or steric stabiliser can be added to the contaminated water during aeration. Preferably, a non-toxic and biodegradable chemical, this will help stabilise the air bubbles, allowing more surface area for the PFAS to adsorb onto in the timeframe of bubble rising to the surface. This allows for higher concentrations of PFAs in the foamate.

In some embodiments, the air pressure and/or the bubble size provided to the second, third and/or fourth vessel is different to that applied to the first vessel. Furthermore, in some embodiments, the air pressure and or the bubble size provided to e.g., the third vessel is different to that applied to the first and or second vessel.

In some embodiments, each foam fractionator can comprise different sized diffusers, pin-wheel pumps, aeration pumps, air whip, venturi tubes or any bubble producing system producing microbubbles and/or fine bubbles needed for the operation with a diameter >1 um. However, these aeration systems are present to supplement the main aeration system which in provided by nanobubble aeration, producing bubbles with a diameter <1 μm. Nanobubbles provide a much higher bubble surface area per unit volume and therefore provide more contact with the contaminant PFAS in the contaminated water.

Bubbles with a diameter of 3 mm are considered to be a large maximum size which to the extent possible, the process attempts to avoid. Course bubble diffusers, venturi and air blocks will have a bubble size of 3 mm to 50 mm. Accordingly the bubbles used in preferred embodiments of the present invention are nanobubbles, most preferably nanobubbles having an average diameter less than 1 um.

### Nanobubble Advantages

As discussed previously, nanobubbles with a 100 nm diameter will have 10 times greater interfacial surface and 1000 more air bubbles per unit area compared to microbubbles with a 1 μm diameter. The combination of the nanobubble aeration system's larger total interfacial surface area, higher air bubble density, stability, and hydrophobicity, increases the attraction and collision rate of the PFAS molecules with the suspended air bubbles, resulting in a higher percentage of PFAS attaching to the air bubbles and consequently removed from the water.

Nanobubble technology is a new field of physics and chemistry. Although nanobubble are finding applications in many areas, it does not appear that nanobubbles have been used to treat PFAS contaminated water. Although aeration technology using larger microbubbles (and macrobubbles) has been used, the applications have been relatively unsuccessful at removing short-chain PFAS molecules (C5 and less).

Larger bubbles are not hydrophobic, nor are they negatively charged, two important short-comings and requirements. Unlike nanobubbles, microbubbles do not increase the adsorption coefficient of the short chain PFAS molecules at the water: air interface. It should be clarified that the water: air interface of a nanobubble is unlike that of a larger microbubble. Although not yet fully understood, it is believed that the oxygen at the interface gives water a highly functional (negatively charged and hydrophobic), adsorptive property.

The first main challenge for scientists to date has been the development of easily controlled methods to promote nanobubble formation and nanobubble release. The discovery of a new, energy-efficient, and easily controlled methods to generate and release large volumes of nanobubbles has been made and such methods have now matured to be industrially feasible.

Micron-sized bubbles are tiny gas bubbles with a diameter of less than 50 micron. However, micron-sized bubbles decrease in size and eventually disappear underwater due to the rapid dissolution of their interior gas, which limits their industrial potential.

Nanobubbles are also tiny gas bubbles but on the nanometer (nm) scale. Nanobubbles are thermodynamically metastable for many months or even longer, in contrast to micron-sized bubbles, and have therefore enhanced gas-transfer properties and greater industrial potential.

Nanobubbles possess unique physiochemical properties. In addition to being thermodynamically metastable, thus not allowing them to rise or coalesce, nanobubbles are also hydrophobic: they repel water and hydrophobic, short-chain, water-soluble polymers are attracted to particle's surfaces. Effectively, nanobubbles in the water serve as seeds.

Proprietary controlled cavitation produces hydrophobic, negatively charged nanobubbles at pH=5-9. The nanobubble surface will turn positive if cations adsorb at the interface. The combination of these surface charge properties enhances the remediation capacity of nanobubbles with respect to PFAS.

The combination of these unique properties has made nanobubbles advantageous in the application of foam fractionation of hydrophobic, anionically charged PFAS in contaminated wastewater. More specifically, nanobubbles allow the practitioner to overcome the low removal percentage of low molecular weight PFAS molecules (C5 and less) caused by the low adsorption coefficient of the lower molecular weight PFAS molecules. The extremely high surface/volume ratio, hydrophobicity, and negative surface zeta potential of the nanobubbles increase the adsorption capacity of the air: water interface and increase the portioning coefficient of the PFAS. Thus, high removals of PFAS can be achieved without the addition of toxic co-surfactants.

The second main challenge has been the fact that, unlike ordinary micro or macrobubbles, nanobubbles do not rise to the surface and burst. As such they can not be used “alone” for foam fractionation applications as no foam can be created and removed from the fractionator or, conversely, to much foam is formed whose bubbles do not burst.

The inventors have discovered that by either doing a sequential injection of nanobubbles followed by micro or macro bubbles, the nanobubbles can be made to float to the top and form a dry foam.

More advantageously, the inventors have discovered that by simultaneously generating nanobubbles and microbubbles and injecting them simultaneously, the same effect was obtained. A large increase in the removal of the PFAS, in particular low molecular weight (C5 and less) was obtained.

The simultaneous addition of nano and microbubbles can be done in either of two ways: the first is the generation of the nanobubbles and microbubbles by two separate generators and co-injecting.

The second makes use of a dissolution tube. In this application the mixing of nanobubbles and microbubbles is done by running the discharge of the nanobubble generator through a dissolution style tube that most dissolved air floatation (DAF) units have. Unlike a DAF, we do not pressurize this section and we do not add air into the tube. It is connected into the piping on the downstream side of the nanobubble generator and provides a wide spot in the line and pressure differential so some of the nanobubbles can increase in size, which can support the separation foam fractionation application further.

These set-up for foam fractionation is novel and solves a problem as to why previously nanobubbles were not used. Without these aspects and features of the solution, the use of nanobubbles would not have worked for contaminant removal from water.

Nanobubbles fulfill the requirements set out above without the need of a co-surfactant: small bubble size, hydrophobicity, and high bubble stability. Specifically:
Higher surface area, more contact with contaminated water/leachate/PFAS (compared to all other fine, course and microbubble options)
Require less energy to run (compared to all other fine, course and microbubble options)
Lower volatile organic compound emissions (compared to all other fine, course and microbubble options)
Less expensive—fine pore diffusers require more routine cleaning and replacement (plus additional costs of maintenance and downtime)
Lower energy cost challenges—when fine pores become clogged, the diffusers may require more energy to operate (than coarse, fine and microbubble diffusers)
Better Air Flow distribution—critical for fine diffuser performance. This requires proper selection of Air Flow Control Systems to ensure fine pore diffusers function 20 at peak efficiency levels.

### Operational Parameters

The other design parameters that need to be determined and optimized include the hydraulic retention time (HRT), superficial gas velocity, the configuration of the vessel e.g., type of fractionator (i.e., column) and the height of the riser (which sets the water depth in the vessel), and the ratio of contaminated water treated per second to volume capacity of vessel. Other details that can be optimised include the bubble size as described above, pressure at the diffuser head, diffuser area coverage and blower specifications. Some of these parameters are elaborated below.

Gas flowrate (superficial air velocity) is a calculated air flow velocity calculated as if the given air phase were the only one flowing or present in a given cross sectional area of an aeration tank. For foam fractionation, a lower gas flowrate (superficial air velocity) is expected to give greater enrichment but reduced recovery and a drier foam. In one preferred embodiment, the gas flowrate (superficial air velocity) during active aeration is in the range of from about 0.0005 to 0.20 m/s, preferably 0.005 to 0.1 m/s.

Gas residence time—enough detention time to extract the maximum amount of PFAS from the liquid. The increase of air flow rate has an obvious impact on the removal rate of PFOA. The more air flow rate means the more bubble, and it can carry more PFAS to the air-water interface and increase the removal rate of PFOA. The time can vary depending on the foam volume, where longer time may be required to achieve the desired amount of foam. In one preferred embodiment, the gas residence time is in the is range of from about 2 to 50 minutes, more preferably 10 to 25 minutes.

Gas type—in some applications it is more advantageous to use other gases rather than atmospheric air. Other gases can be, but not limited to, nitrogen, helium, ozone, pure oxygen.

Hydraulic (water) residence time (HRT) of recirculated Water—enough flow is required to allow the movement of the water so that the bubbles and PFAS from the liquid contact each other. The time can vary depending on the foam volume, where longer time may be required to achieve the desired amount of foam. In one preferred embodiment, the hydraulic residence time is in the is range of from about 1 to 60 minutes, more preferably 5 to 25 minutes.

The air to water ratio flowing through the tank—the increase of air flow rate has an obvious impact on the removal rate of PFAS. The more air flow rate means the more bubble, and it can carry more PFOA to the air-water interface and increase the removal rate of PFAS. This fact indicates the air/liquid ratio can be an important operational parameter for PFAS removal by foam flotation. The ratio can vary depending on the foam volume, where higher ratios may be required to achieve the desired amount of foam. In one preferred embodiment, the air to water ratio range is from about 0.1 to 40, more preferably 0.2 to 1.0.

Bubble size—as described above, smaller bubbles will provide more surface area for adsorption, but they do not dewater as easily and as the raw wastewater foams strongly with very small bubbles. On the other hand, production of larger bubbles requires less energy and dewater better, but PFAS capture may not be as good. In this embodiment, the air bubbles injected in the aeration tank (in terms of air volume) are a combination of nanobubbles plus microbubbles and/or fine bubbles. The ratio of nanobubbles to fine/microbubbles can vary depending on the foam volume, dewatering and desired PFAS removal, where larger ratios may be required to achieve the desired amount of foam. In one preferred embodiment, the ratio is in the is range of from about 1 to 100%, more preferably 10 to 50%.

Fractionator and configuration In one preferred embodiment, the liquid is retained in each aeration vessel for an active aeration stage lasting at least 15 minutes, although lesser times are possible with higher carbon chain PFAS molecules and/or PFAS with very high adsorption coefficients.

Where there are two stages of active aeration, the total residence time in one preferred embodiment is 30 minutes. Where there are three stages of active aeration the total residence time is 45 minutes. Where there are four stages of active aeration the total residence time is 60 minutes. In embodiments, even after optimisation of the first and second processes, the foamate waste stream with the second and third PFAS concentration will likely benefit in further volume reduction to minimise the cost of destruction and/or disposal. Volume reduction is particularly desirable when the foamate has to be stored or ultimately transported off-site for disposal or incineration.

Volume reduction is by passing the foamate (that has a concentration of PFAS) through a further process, to produce a more concentrated waste stream that has a PFAS concentration that is higher than the previous concentrations. The process can include additional (e.g., four or possibly more) processes to further concentrate the PFAS in the stream.

The present process may result in at least about a 10-to-10,000-fold reduction in PFAS concentration of the contaminated waste volume. There are multiple processes in the method. The processes are sequential and not concurrent meaning that each process that occurs after an earlier process is reliant on the outcome of the earlier process for feed. In embodiments there are five processes in the method for the removal of PFAS.

These five processes can comprise a first stage of membrane filtration, preferably through a reverse osmosis membrane, three stages of active aeration, one final stage of destruction.

The processes can be operated continuously. The smaller size of the second vessel can be achieved if the method is run continuously. Alternatively, and preferably, the process is operated batch-wise, where the waste having the first PFAS concentration is collected until there is enough waste (e.g., foamate) for economical treatment. The size of the vessel can be scaled to accommodate batch flow.

### DETAILED DESCRIPTION OF EMBODIMENTS

Foam Fractionation is a chemical engineering process in which hydrophobic molecules are preferentially separated from a liquid solution using rising columns of foam. It is commonly used, albeit on a small scale, for the removal of organic waste from aquariums; these units are known as “protein skimmers”.

The fundamental principle behind the novel technology described herein is a variation of the process of foam fractionation. Surprisingly foam fractionation can also be used for the removal of surface-active contaminants from wastewater streams. PFAS molecules are usually quite surface active, meaning that they are inherently attracted to air/water interfaces. This new water treatment technology takes advantage of this property of PFAS molecules.

A key element is the introduction of gas (typically air) bubbles well below the water level of a sample of PFAS contaminated water using a specific bubble diffuser system. As the bubbles mix with the water and rise to the surface, the surfaces of the bubbles are energetically stabilised by the surface active PFAS molecules, which diffuse from the bulk of the water to the bubbles and then adsorb onto the surfaces of the bubbles. This process prevents the bubbles from coalescing. When the bubbles reach the surface of the water sample, foam is formed at the surface. This foam, which is highly concentrated in PFAS, can then be removed from the surface, dewatered, and transported to a treatment plant for safe disposal or destruction. By these means a PFAS can be removed from a contaminated water sample.

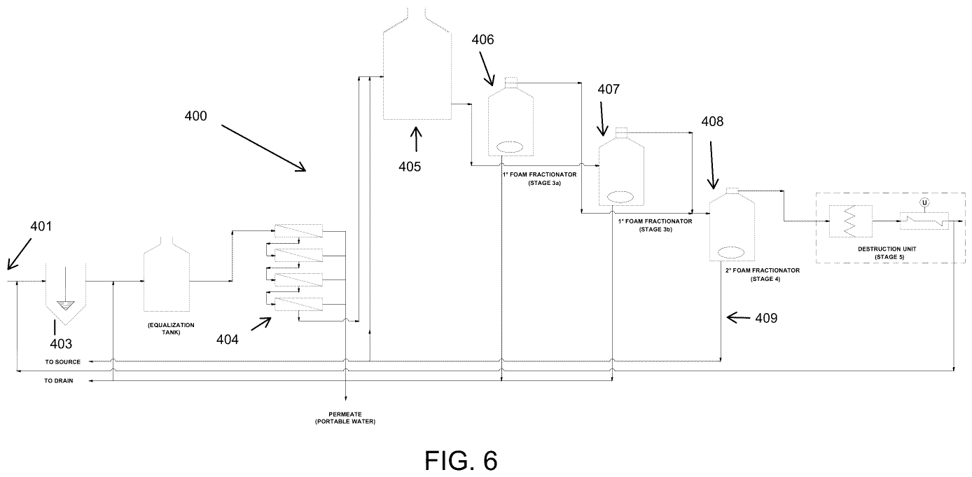

FIG. 6 (oriented in landscape) shows a schematic of a typical ex-situ treatment system for contaminated water comprising PFAS (400). FIG. 6 shows the stages of treatment for the above ground method for generating a highly PFAS concentrated waste stream. The foam fractionation process is completely contained within large custom shipping containers, in one embodiment 40-foot containers are use. FIGS. 4 and 5 show a typical schematic of the layout. The front container depicts two parallel plumbed 3.2 m³ aeration tanks that function as the primary fractionation stages, whereas the 1.0 m³ vessel towards the right functions as the secondary/tertiary fractionation stages. The vacuum system and foamate knockout/transfer tank are contained within the container. The container also houses the proprietary nanobubble technology, and micro/fine bubble aeration systems.

If optional polishing is required, the GAC and AIX resin polishing process will be housed outside the 40-foot container. They will operate in a continuous flow-through mode (including a water recirculation circuit to prevent AIX resin from degrading due to potential mismatched semi batch foam fractionation and continuous flow resin requirements arising from feedwater supply interruption).

FIG. 6 shows the introduction of the PFAS contaminated waste (401). Stage 1 (402): Pre-treatment of incoming wastewater: The pre-treatment stage is a precautionary process to remove solid particles from the feed to the foam fractionation train. This stage can be comprised of any necessary process which will remove solids particles, metal ions and any other interfering substance. It can be any system running in parallel or in sequence. It can be constituted of screens, sedimentation tank, coalescing plate separator, DAF, SAF or any other appropriate treatment.

An automated acid-base dosing system is installed pre-reverse osmosis (R/O) to ensure process water presented to the R/O stage has an appropriate pH to avoid fouling.

Stage 2 (404): Reverse-Osmosis: The R/O pretreated water is subsequently passed through membrane filtration such as reverse osmosis (RO) and nanofiltration (NF) which can effectively remove the totality of the PFAS. Approximately 10-25% of the treated water volume is reject produced from RO and NF processes and needs further treatment (going to the R/O reject tank 405). The advantage of the present invention is that reverse osmosis and foam fractionation are effectively combined to result in a highly effective, low-cost alternative compared to traditional reverse osmosis or traditional foam fractionation as a stand-only technique. It should be noted that this stage can be by-passed if necessary if the pretreated water is found not to need R/O concentration.

Stage 3a and 3b: Primary foam fractionation: The R/O treated water is then sent to the primary foam fractionators 406 and 407. The SAFF process operates in a semi batch mode (i.e., batch with respect to the liquid phase and continuous with respect to the gaseous [air] phase). The primary fractionation stages are, in fact, comprised of 2 vessels fabricated from high-density polyethylene (HDPE), with a volume of 3.2 m³. Any appropriate material can be used to build the vessels. The operation of each successive vessel is offset by at least 5 minutes such that they fill with contaminated water after pre-treatment or R/O treatment via a transfer tank in turn. Each of the primary foam fractionators is aerated for at least 10 minutes using the aeration system. The plumbing for the system is set-up within the container such that one of the primary fractionators can be converted to a secondary fractionator.

Stage 4: Secondary foam fractionation: The extracted foam from the primary fractionators is then sent to the secondary foam fractionator(s) (408). The 1.0 m³ vessel can functions as the secondary or tertiary fractionation stages (depending on the primary fractionator configuration). Because the volume reduction of foamate versus feed to an individual fractionator is substantial, the secondary foam fractionation can be conducted in the secondary foam fractionation column much less often, typically once 3-4 hours up to a number of weeks. This will depend on the fractionator efficiency at removing the PFAS.

The aerated, cleaned water (low PFAS concentration) is sent back to the R/O or pre-treatment stage for further PFAS removal (path shown at 409), preferably the pre-R/O stage.

Stage 5: Photo-reductive destruction: This stage is shown within the dotted lines. The extracted foam from the secondary fractionators is then sent to the Photo-reductive destruction system (PRD). A wide variety of technologies to remove or destroy PFASs have been tested by the authors. The preferred technology is based on a photoactivated reductive defluorination (PRD) process. PRD is a unique chemistry coupled with ultraviolet light to stimulate a reaction with a catalyst which systematically disassembles and mineralizes PFAS molecules to water, fluoride, and simple carbon compounds.

Although photo-reductive destruction is favored, any other technology that can mineralize PFAS effectively can be used.

The treated water from the PRD is sent back to the pre-treatment or R/O stage from further treatment, preferably pre-treatment.

The aerated, clean water from the primary fractionation stages is optionally polished. The polishing stage comprises a single-pass GAC guard column of sufficient volume (e.g., 1000 kg Oxpure 1240B-9) to remove dissolved organic compounds, followed by a selective AIX resin configured in a lead-lag column arrangement followed by additional AIX resin columns also configured in a lead-lag arrangement to remove short-chain PFAS species, if required.

### Aeration Process and Strategy

The removal of PFAS is greatly enhanced in the aeration in stages 3a (407), 3b (408) and 4 (411) by providing the process with nanobubbles. In a typical application nanobubbles are injected into the vessel in tandem with larger sized micro or fine bubbles. The ratio of nanobubbles to fine/microbubbles can vary depending on the foam volume, dewatering and desired PFAS removal, where larger ratios may be required to achieve the desired amount of foam. In this embodiment, the ratio is in the is range of from about 1 to 100%, more preferably 10 to 50%.

The fine and microbubble aeration is needed to “lift” the nanobubbles out of solution as their buoyancy is much higher than that of nanobubbles.

The use of needle wheel pumps (also called pin-wheel pumps) may be more advantageous than other aeration technologies currently used in foam fractionation such as aeration pumps or blowers, air whip, venturi tubes, diffusers or any bubble producing system producing microbubbles and/or fine bubbles used in air fractionation devices. These pumps may be used in an embodiment of the system.

In particular, the use of diffusers is prone to the accumulation of scale at their surface when the water being treated is found to have a hardness greater than 100 ppm. Scale blocks the pores of the diffusers thus reducing their efficiency. Venturi produces large bubbles which are much less effective than needle wheel or air whip pumps and require large pumps (more power). Air whip pumps are not capable of entraining as large a proportion of air to water as pin-wheel pumps and also tend to consume larger amounts of power.

Needle wheels do not have problems with scaling at their surface. In particular needle wheel pumps are able to entrain large amounts of air to water ratios with very low power consumption.

### EXAMPLE

### Chemicals and Materials

All PFAS listed in Tables 3 and 4 were obtained from Millipore Sigma Canada. The purity was >98% S and their detailed information is listed in the Tables. Standard solutions (stock solutions) were prepared for each PFAS and sent to Bureau Veritas Canada labs for analysis to confirm final concentration and impurities. Sodium hydroxide (NaOH, AR grade) and hydrochloric acid (HCl, AR grade) were also purchased from Millipore Sigma. Ultrapure Milli Q water was used in all the experiments. The surfactant, cetyl-trimethyl-ammonium bromide (CTAB, C19H42BrN) was also purchased from Millipore-Sigma.

### Laboratory Testing—Aeration and Foam Collection Device (500):

A modified RK2 XFLO XF6-3.5 Venturi with Vectra M1 recirculation pump feeding a Mazzei 784 venturi (501) was used for the experiments. The modifications included the addition of a micro-bubble pump and a nanobubble production system (502). The Vectra M1 pump provided a water recirculation rate of 12 litres per minute which resulted in a hydraulic retention time and air was feed at a rate of 5-20 litres per minute, depending on the stage of foaming and extent of foaming. The superficial air velocity was 0.004 to 0.020 m/s.

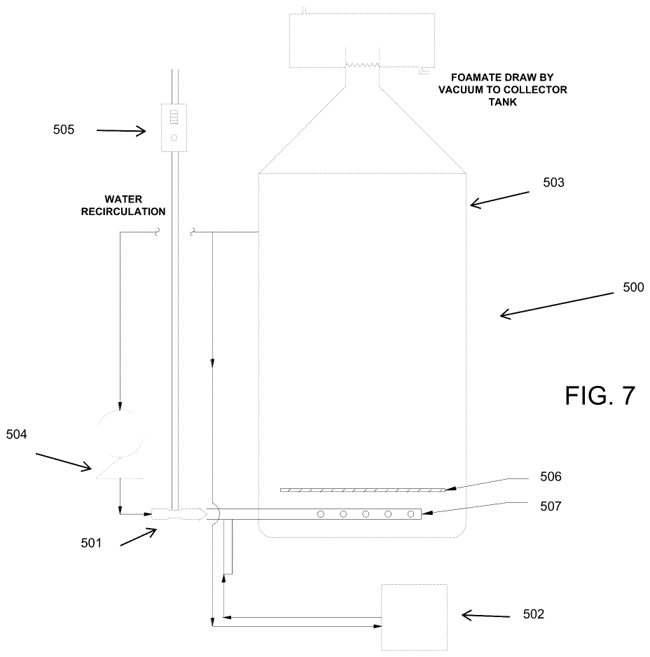

The vessel (503) was initially sparged for 1 minute with nanobubbles to saturate vessel water. After 1 minute the foam recirculation pump (504) was started where 25% of the air injected into the vessel was from the nanobubble aeration system. Thus, for example, if 10 litres of air were being injected into the vessel per minute, 7.5 litres were from the venturi and 2.5 was from the nanobubble system. The air was monitored and controlled via an air flow inlet monitoring and control (505). A schematic is shown in FIG. 7. The vessel also has an air diffusion plate (506) and an air inlet (507).

Tables 3 and 4 show the data comparing the use of nanobubble technology to treat PFAS from wastewater versus no nanobubble air injection. The initial PFAS solution concentrations are provided as well as the treated PFAS solution concentrations with and without the use of a co-surfactant, CTAB. The co-surfactant was used at a concentration of 1 ppm. The pH of the solution was maintained at 7.

For Table 3, low PFAS wastewater concentration, the improvement using nanobubble technology with no co-surfactant (CTAB) exceeded those obtained using the venturi with or without CTAB (93% removal versus 74-77%, respectively). When CTAB is also used with the nanotechnology, the improvements are also seen to be nominally greater (93% to 98%). It is interesting to note that almost 100% removal of PFAS is achieved with nanobubble technology when the initial contaminated water is low in total PFAS concentration. The bottom row of each portion of the chart is the Total PFAS % removal; the penultimate row is the sum.

TABLE 3
Improvement in Low Initial PFAS Solution Concentration using
nanobubble technology with no co-surfactant (CTAB)
Table 3: Low Initial PFAS Solution Concentration

| | | | | Initial |
|---|---|---|---|---|
| PFAS Ribbon graph: AACO's 3M Lightwater Signature (OPEC) | | | | ppb |
| Analyte | C-Chain | Name | Analyte | (BV lab) |
| PFBA | C3 | Perfluorobutanoic acid | PFBA | 130 |
| PFBS | C4 | Perfluorobutanesulfonic acid | PFBS | 240 |
| PFHxS | C6 | Perfluorohexanesulfonic acid | PFHxS | 9.2 |
| PFHpS | C7 | Perfluoroheptanesulfonic acid | PFHpS | 16 |
| PFHpA | C7 | Perfluorheptanoic acid | PFHpA | 61 |
| PFOS | C8 | Perfluoroctanesulfonic acid | PFOS | 540 |
| PFOA | C8 | Perfluorooctanoic acid | PFOA | 180 |
| PFDA | C10 | Perflourodecanoic acid | PFDA | 87 |
| | | | Sum | 1263 |
| | | | Total PFAS % | |
| | | | removal | |

VENTURI AERATION SYSTEM

| Treated | % Removal | Treated | % Removal |
|---|---|---|---|
| Conc. | per | Conc. | per |
| ppb | compound | Ppb | compound |
| pH = 7/0 ppm CTAB | | pH = 7/1 ppm CTAB | |
| 87 | 33 | 79 | 39 |
| 66 | 73 | 59 | 75 |
| 2 | 74 | 2 | 78 |
| 3 | 83 | 2 | 87 |
| 26 | 57 | 22 | 64 |
| 98 | 82 | 91 | 83 |
| 23 | 87 | 19 | 89 |
| 24 | 72 | 20 | 77 |
| 329 | | 294 | |
| 74 | | 77 | |

| NANOBUBBLE AERATION SYSTEM | | | | % | % |
|---|---|---|---|---|---|
| Treated | % Removal | Treated | % Removal | Improvement | Improvement |
| Conc. | per | Conc. | per | pH = 7 | pH = 7 |
| ppb | compound | Ppb | compound | 0 ppm | 1 ppm |
| pH = 7/0 ppm CTAB | | pH = 7/1 ppm CTAB | | CTAB | CTAB |
| 52 | 60 | 15 | 88 | 81 | 125 |
| 19 | 92 | 9 | 96 | 27 | 28 |
| 0 | 100 | 0 | 100 | 35 | 28 |
| 0 | 100 | 0 | 100 | 21 | 15 |
| 15 | 75 | 0 | 100 | 31 | 56 |
| 3 | 99 | 0 | 100 | 21 | 20 |
| 3 | 99 | 0 | 100 | 13 | 12 |
| 0 | 100 | 0 | 100 | 38 | 30 |
| 92 | | 24 | | | |
| 93 | | 98 | | | |

Table 4, high PFAS wastewater concentration, the trends are similar. Improvement using nanobubble technology exceed those obtained using the venturi only with or without CTAB (95% versus 86-91%, respectively). When CTAB is also used the improvements are also greater. The % improvements are not as large due to a higher foaming tendency of the wastewater resulting from the higher PFAS solution concentration.

TABLE 4
Improvement in Low Initial PFAS Solution Concentration using
nanobubble technology with no co-surfactant (CTAB)
High Initial PFAS Solution Concentration

| | | | | Initial Conc. |
|---|---|---|---|---|
| Analyte | C-Chain | Name | Analyte | (ppb) |
| PFBA | C3 | Perfluorobutanoic acid | PFBA | 5300 |
| PFBS | C4 | Perfluorobutanesulfonic acid | PFBS | 2500 |
| PFHxS | C6 | Perfluorohexanesulfonic acid | PFHxS | 580 |
| PFHpS | C7 | Perfluoroheptanesulfonic acid | PFHpS | 1000 |
| PFHpA | C7 | Perfluorheptanoic acid | PFHpA | 2600 |
| PFOS | C8 | Perfluoroctanesulfonic acid | PFOS | 36000 |
| PFOA | C8 | Perfluorooctanoic acid | PFOA | 7500 |
| PFDA | C10 | Perflourodecanoic acid | PFDA | 320 |
| | | | Sum | 55800 |
| | | | Total PFAS % | |
| | | | removal | |

VENTURI AERATION SYSTEM

| | | | |
|---|---|---|---|
| Treated | % Removal | Treated | % Removal |
| Conc. | per | Conc. | per |
| Ppb | compound | Ppb | compound |

| | | | |
|---|---|---|---|
| Analyte | C-Chain | pH = 7/0 ppm CTAB | pH = 7/1 ppm CTAB |

| | | | | | |
|---|---|---|---|---|---|
| PFBA | C3 | 2200 | 58 | 1800 | 66 |
| PFBS | C4 | 1100 | 56 | 870 | 65 |
| PFHxS | C6 | 58 | 90 | 23 | 96 |
| PFHpS | C7 | 140 | 86 | 47 | 95 |
| PFHpA | C7 | 590 | 77 | 530 | 80 |
| PFOS | C8 | 3400 | 91 | 1400 | 96 |
| PFOA | C8 | 430 | 94 | 330 | 96 |
| PFDA | C10 | 0 | 100 | 0 | 100 |
| | SUM | 7918 | | 5000 | |
| | Total PFAS | 86 | | 91 | |
| | % removal | | | | |

| | | | | | | % | % |
|---|---|---|---|---|---|---|---|
| | | NANOBUBBLE AERATION SYSTEM | | | | Improve- | Improve- |
| | | Treated | % Removal | Treated | % Removal | ment | ment |
| | | Conc. | per | Conc. | per | pH = 7 | pH = 7 |
| | | Ppb | compound | Ppb | compound | 0 ppm | 1 ppm |
| Analyte | C-Chain | pH = 7/0 ppm CTAB | | pH = 7/1 ppm CTAB | | CTAB | CTAB |
| PFBA | C3 | 1700 | 68 | 1200 | 77 | 16 | 17 |
| PFBS | C4 | 770 | 69 | 600 | 76 | 24 | 17 |
| PFHxS | C6 | 0 | 100 | 0 | 100 | 11 | 4 |
| PFHpS | C7 | 0 | 100 | 0 | 100 | 16 | 5 |
| PFHpA | C7 | 500 | 81 | 95 | 96 | 4 | 21 |
| PFOS | C8 | 20 | 100 | 0 | 100 | 10 | 4 |
| PFOA | C8 | 26 | 100 | 26 | 100 | 6 | 4 |
| PFDA | C10 | 0 | 100 | 0 | 100 | 0 | 0 |
| | SUM | 3016 | | 1921 | | | |
| | Total PFAS % | 95 | | 97 | | | |
| | removal | | | | | | |

### Pilot Testing

A test pilot was built with a treatment capacity of 50,000 gallons per day. FIGS. 3A, 3B, 4, 5A, 5B and 6 show the general layout and process flow of the pilot. Leachate from a landfill was treated using the pilot. Analysis of the leachate is show in Table 5. The total PFAS concentration in the leachate was found to be roughly 17,000 ng/L and mainly comprised of short-chain perfluoroalkane sulfonic acid (PFBS) and short-chain perfluoroalkyl carboxylic acid (PFHxA and PFBA).

TABLE 5
Leachate Analysis

| Inorganics | UNITS | Total | RDL |
|---|---|---|---|
| Total Ammonia-N | mg/L | 2000 | 5 |
| Total BOD | mg/L | 580 | 2 |
| Total Chemical Oxygen Demand (COD) | mg/L | 3700 | 160 |
| Total Dissolved Solids | mg/L | 18400 | 20 |
| pH | pH | 7.86 | |
| Total Suspended Solids | mg/L | 30 | 2 |
| Nitrate (N) | mg/L | ND | 5 |

Organic Halogens

| | | | |
|---|---|---|---|
| Total Organofluorine | ug/L | 110 | 25 |

Perfluorinated Compounds

| | | | |
|---|---|---|---|
| Perfluorobutanoic acid (PFBA) | ng/L | 2400 | 200 |
| Perfluoropentanoic acid (PFPeA) | ng/L | 1200 | 200 |
| Perfluorohexanoic acid (PFHxA) | ng/L | 3200 | 200 |
| Perfluoroheptanoic acid (PFHpA) | ng/L | 540 | 20 |
| Perfluorooctanoic acid (PFOA) | ng/L | 1500 | 200 |
| Perfluorononanoic acid (PFNA) | ng/L | 66 | 20 |
| Perfluorodecanoic acid (PFDA) | ng/L | 58 | 20 |
| Perfluoroundecanoic acid (PFUnA) | ng/L | ND | 20 |
| Perfluorododecanoic acid (PFDoA) | ng/L | ND | 20 |
| Perfluorotridecanoic acid (PFTRDA) | ng/L | ND | 20 |
| Perfluorotetradecanoic acid(PFTEDA) | ng/L | ND | 20 |
| Perfluorobutanesulfonic acid (PFBS) | ng/L | 7000 | 200 |
| Perfluoropentanesulfonic acid PFPes | ng/L | 280 | 20 |
| Perfluorohexanesulfonic acid(PFHxS) | ng/L | 540 | 20 |
| Perfluoroheptanesulfonic acid PFHpS | ng/L | ND | 20 |
| Perfluorooctanesulfonic acid (PFOS) | ng/L | 210 | 20 |
| Perfluorononanesulfonic acid (PFNS) | ng/L | ND | 20 |
| Perfluorodecanesulfonic acid (PFDS) | ng/L | ND | 20 |
| Perfluorooctane Sulfonamide (PFOSA) | ng/L | ND | 40 |

| | |
|---|---|
| Total | 16,994 |

Petroleum Hydrocarbons

| | | | |
|---|---|---|---|
| Total Oil & Grease | mg/L | 7.2 | 0.5 |

The pilot is equipped with both nano-aeration and micro-aeration capabilities. Pilot data shown in Table 6 show the effectiveness of nanobubble aeration technology compared to microbubble aeration. Four test protocols were used to compare the aeration technologies:
(1) Low level microbubble aeration-air flow of 140 SCFH and water flow of 80 gpm (air: water ratio=0.21)
(2) High level microbubble aeration-air flow of 280 SCFH and water flow of 160 gpm (air: water ratio=0.21)
(3) Low level Nanobubble aeration-air flow of 160 SCFH and water flow of 100 gpm (air: water ratio=0.20)
(4) High level Nanobubble aeration-airflow of 220 SCFH and water flow of 100 gpm (air: water ratio=0.28)

### Microbubble Aeration

Low level microbubble aeration reduced to total PFAS concentration in the leachate by 41%. It was effective at removing 100% of the long chain PFAS compounds within 20 minutes. However, it had a reduced effectiveness at removing the short chain PFAS compounds, achieving 16-30% removal rates. The results demonstrate that the overall water and air flow was too low.

PFHxA was found to be a difficult compound to remove, with only 16% removal. PFBA removal rate was 29%. The air: water ratio was 0.21.

The high-level microbubble aeration, with twice the water and air flows, showed a large improvement for total PFAS compound removal. An overall removal rate of 57% was achieved with a significant partial removal of short chain PFAS molecules (31-54%). The long chain PFAS molecules showed 100% removal within 10 minutes. These results are in agreement with data published in other pilot studies using venturi aeration technology or equivalent microbubble technology. It should be noted, however, that other pilot studies show a maximum PFAS removal at time T >20 minutes, whereas the present pilot microbubble technology can achieve the same result in less than 10 minutes at significantly lower power consumption.

Again, PFHxA was found to be a difficult compound to remove, achieving a higher removal rate of 32%. PFBA removal rate was 54%. This is in line with twice the increased air flow but similar air: water ratio of 0.21.

### Nanobubble Aeration

Low level nanobubble aeration, on the other hand, was found to be extremely effective. Overall, it achieved a total removal rate of 74% and a short chain PFAS removal rate of 63-79%. Long chain PFAS compounds were removed within 5 minutes compared to 10-20 minutes in the previous two test protocols. It should be pointed out that the water and air flows were only slightly highly than in test protocol 1—thus showing the extreme effectiveness of nanobubble aeration technology when applied to foam fractionation. The water flow was set 100 gpm and air flow was set at 160 SCFH.

PFHxA, which previous microbubble technology had problems removing, was found to have a removal rate of 63%. PFBA removal rate was 79%. This was achieved with slightly lower air: water ratio of 0.20.

The nanobubble aeration technology tested in the pilot did not make use of CTAB.

High level nanobubble aeration was also conducted as a continuation to test protocol 3 to show the effectiveness of a higher air flow rate. This was done as follows: at the end of the 60-minute run for the low level nanobubble aeration, the air flow was increased from 160 SCFH to 220 SCFH for the nanobubble generator. This was done for a period of 20 minutes with collection of the sample at T=70 and 80 minutes. The resultant data showed the effectiveness of increasing air flow. The overall PFAS removal was found to increase from 57% to 96%. Total Short chain PFAS removal was >95% for all PFAS compounds tested. It should be noted that the air flow for this test protocol was still lower than the high-level microbubble aeration (220 SCFH vs 280 SCFH), thus again showing nanobubble efficacy.

PFHxA was found to have a 100% removal rate with the high level nanobubble aeration technology at a higher air: water ratio of 0.28. PFBA removal rate was 100%.

TABLE 6
Leachate Pilot Study

| | | | Short-Chain | Long-Chain | | | | Long-Chain | |
|---|---|---|---|---|---|---|---|---|---|
| | | | perfluoro- | perfluoro- | | | | perfluoro- | |
| | | | alkane | alkane | | | | alkyl | |
| | | | sulfonic | sulfonic | Short-Chain perfluoroalkyl | | | carboxylic | |
| | | | acid | acid | carboxylic acid | | | acid | |
| | | | Perfluoro Compound | | | | | | |
| | | | PFBS | PFHxS | PFBA | PFHxA | PFHpA | PFOA | |
| | | | Name: | | | | | | |
| | | | Nanofluoro- | Perfluoro- | | | | | |
| | | | butane- | hexane | Perfluoro- | Perfluor- | Perfluor- | Perfluoro- | |
| | | | 1-sulfonic | sulfonic | butanoic | hexanoic | heptanoic | octanoic | |
| | | | acid | acid | acid | acid | acid | acid | |
| | | | Carbon Chain: | | | | | | |
| | | | C4 | C6 | C3 | C6 | C7 | C8 | |
| | | | % error | | | | | | Total |
| | Time | | 2 | 2 | 2 | 5 | 6 | 2 | PFAS |
| | (minutes) | pH | ng/L | ng/L | ng/L | ng/L | ng/L | ng/L | ng/L |
| Air Flow: | 0 | 8.06 | 7000 | 600 | 2400 | 3200 | 670 | 1800 | 15670 |
| 140 SCFH - | 5 | 8.07 | 4900 | 0 | 2100 | 2700 | 610 | 1200 | 11510 |
| Water Flow | 10 | 8.09 | 5000 | 0 | 1900 | 3000 | 590 | 920 | 11410 |
| 80 gpm | 20 | 8.20 | 4800 | 0 | 1800 | 2700 | 540 | 0 | 9840 |
| (Micro- | 30 | 8.20 | 5000 | 0 | 1800 | 3000 | 0 | 0 | 9800 |
| bubble | 45 | 8.20 | 5000 | 0 | 1700 | 3000 | 0 | 0 | 9700 |
| aeration) | 60 | 8.20 | 4900 | 0 | 1700 | 2700 | 0 | 0 | 9300 |
| | % | | 30 | 100 | 29 | 16 | 100 | 100 | 41 |
| | Reduction | | | | | | | | |
| | pH | | | | | | | | |
| Air Flow: | 0 | 8.03 | 7000 | 520 | 2400 | 2900 | 730 | 1400 | 14950 |
| 280 SCFH - | 5 | 8.08 | 4000 | 0 | 1900 | 2100 | 460 | 660 | 9120 |
| Water Flow | 10 | 8.10 | 3900 | 0 | 1700 | 2100 | 0 | 450 | 8150 |
| 160 gpm | 20 | 8.14 | 3900 | 0 | 1600 | 2400 | 0 | 0 | 7900 |
| (Micro- | 30 | 8.19 | 3600 | 0 | 1400 | 2100 | 0 | 0 | 7100 |
| bubble | 45 | 8.26 | 3600 | 0 | 1200 | 2000 | 0 | 0 | 6800 |
| aeration) | 60 | 8.32 | 3400 | 0 | 1100 | 2000 | 0 | 0 | 6500 |
| | % | | 51 | 100 | 54 | 31 | 100 | 100 | 57 |
| | Reduction | | | | | | | | |
| Air Flow: | 0 | 8.03 | 10000 | 800 | 2800 | 4000 | 1000 | 1900 | 20500 |
| 160 SCFH - | 5 | 8.10 | 5400 | 0 | 2400 | 2300 | 630 | 880 | 11610 |
| Water Flow | 10 | 8.13 | 4400 | 0 | 1900 | 2100 | 540 | 560 | 9500 |
| 100 gpm | 15 | 8.14 | 4000 | 0 | 1600 | 2000 | 0 | 0 | 7600 |
| (Nano- | 20 | 8.16 | 4000 | 0 | 1200 | 1900 | 0 | 0 | 7100 |
| bubble | 30 | 8.20 | 4000 | 0 | 1000 | 1800 | 0 | 0 | 6800 |
| aeration) | 45 | 8.28 | 3900 | 0 | 800 | 2000 | 0 | 0 | 6700 |
| | 60 | 8.32 | 3200 | 0 | 600 | 1500 | 0 | 0 | 5300 |
| | % | | 68 | 100 | 79 | 63 | 100 | 100 | 74 |
| | Reduction | | | | | | | | |
| Air Flow: | 70 | 8.37 | 1600 | 0 | 0 | 900 | 0 | 0 | 2500 |
| 220 SCFH - | 80 | 8.42 | 800 | 0 | 0 | 0 | 0 | 0 | 800 |
| Water Flow | % | | 92 | 100 | 100 | 100 | 100 | 100 | 96 |
| 100 gpm | Reduction | | | | | | | | |
| (Nano- | | | | | | | | | |
| bubble [symbol] | | | | | | | | | |

[symbol]

indicates data missing or illegible when filed

Disclosed is a method and system for removing contaminants from a water media that incorporates nanobubble technology to cause a foam fractionation of surface-active molecules such as PFAS. Removal efficiencies of short chain PFAS molecules (C<7) are >95% and long chain PFAS molecule (C>6) removals are >99% for PFAS contaminated water. The method is equally effective with low initial PFAS contaminant concentrations, where a low PFAS concentration is defined as <300 ppt total PFAS concentration. The method and system can be accomplished without use of co-surfactants, anionic, cationic, or non-ionic. Ozone, pure oxygen, air, or nitrogen are examples of suitable gases, without limitation.

Certain features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

What is claimed:

1-49. (canceled)

50. A method of removing PFAS compounds from a water media comprising: introducing nanobubbles into the water media thereby forming a nanobubble foam and causing a separation of short-chain PFAS compounds from the contaminated water media.

51. The method of claim 50, wherein the nanobubbles have a diameter between about 10 nm and 600 nm.

52. The method of claim 50, wherein a suitable gas or gas mixture is used to generate the nanobubbles.

53. The method of claim 50, wherein co-surfactants are not utilized.

54. The method of claim 50, wherein greater than 95% of the short-chain PFAS compounds are removed from the water media.

55. The method of claim 50, wherein the nanobubbles are hydrophobic and/or negatively charged nanobubbles.

56. The method of claim 50, wherein the water media has a pH=5-9.

57. The method of claim 50, wherein the nanobubbles are generated through a cavitation process.

58. The method of claim 50, wherein the nanobubbles saturate the water media.

59. The method of claim 50, wherein the short-chain PFAS molecules comprise Nanofluorobutane-1-sulfonic acid (PFBS), Perfluorobutanoic acid (PFBA), Perfluorhexanoic acid (PFHxA) and/or Perfluorheptanoic acid (BFHpA) and/or mixtures thereof.

60. A method, comprising:
introducing nanobubbles into a fluid containing one or more short-chain PFAS molecules,
causing the fluid to form a nanobubble foam to cause a separation of one or more of the PFAS molecules from the fluid.

61. The method of claim 60, wherein the nanobubbles have a diameter between 10 nm and 600 nm.

62. The method of claim 60 wherein a suitable gas or gas mixture is used to generate the nanobubbles.

63. The method of claim 60, wherein co-surfactants are not utilized.

64. The method of claim 60, wherein greater than 95% of short-chain PFAS molecules are removed from the fluid.

65. The method of claim 60, wherein the nanobubbles are hydrophobic and/or negatively charged nanobubbles.

66. The method of claim 60, wherein the fluid has a pH=5-9.

67. The method of claim 60, wherein the nanobubbles are generated through a cavitation process.

68. The method of claim 60, wherein the nanobubbles saturate the fluid.

69. The method of claim 60 wherein the short-chain PFAS molecules comprise Nanofluorobutane-1-sulfonic acid (PFBS), Perfluorobutanoic acid (PFBA), Perfluorhexanoic acid (PFHxA) and/or Perfluorheptanoic acid (BFHpA) and/or mixtures thereof.
